(19) United States
(12) Patent Application Publication
(10) Pub. No.: US 2013/0242391 A1
(43) Pub. Date: Sep. 19, 2013

(54) OPTICAL DEVICE AND METHOD FOR MANUFACTURING SAME

(71) Applicant: HITACHI CONSUMER ELECTRONICS CO., LTD., Tokyo (JP)

(72) Inventors: Hiroyuki MINEMURA, Kokubunji (JP); Yumiko ANZAI, Saitama (JP)

(73) Assignee: HITACHI CONSUMER ELECTRONICS CO., LTD., Tokyo (JP)

(21) Appl. No.: 13/758,133

(22) Filed: Feb. 4, 2013

(30) Foreign Application Priority Data
Mar. 15, 2012 (JP) 2012-058519

(51) Int. Cl. G02B 5/30

(52) U.S. Cl. CPC G02B 5/3066
USPC 359/485.01; 427/163.1

(57) ABSTRACT

In a first face and a second face of an irregular configuration portion configuring a wire grid structure, surface roughness of the first face farther from an input side of a light (electromagnetic wave) is made rougher than the surface roughness of the second face closer to the input side of the light (electromagnetic wave). With this configuration, according to this embodiment, since a reflection polarization element can be realized, there can be provided an optical device that is excellent in tolerance to heat and light, and contributes to a reduction in the costs.

### CLAIM OF PRIORITY

The present application claims priority from Japanese patent application JP 2012-058519 filed on Mar. 15, 2012, the content of which is hereby incorporated by reference into this application.

### FIELD OF THE INVENTION

The present invention relates to an optical device and a technique for manufacturing the optical device, and more particularly to a useful technique which is applied to an optical device having both functions of a reflective mirror and a polarization plate, and a manufacturing technique for the optical device.

### BACKGROUND OF THE INVENTION

Japanese Unexamined Patent Application Publication No. 2011-123474 and Japanese Unexamined Patent Application Publication No. 2009-210672 disclose a technique related to a wire grid polarization element having a metal lattice structure.

Japanese Unexamined Patent Application Publication No. 2011-81154 discloses a technique related to a reflection wave plate that a phase difference between different polarized lights with a structure in which a metal lattice structure and a reflective mirror are combined together, without provision of a function as the polarization element.

### SUMMARY OF THE INVENTION

The optical apparatus has widely generally been popularized, and an optical device that controls a light has been frequently used in, for example, a liquid crystal projector, a display, an optical pickup, and an optical sensor. With advanced functions of those devices, higher functions, higher added values, and lower costs have also been required for the optical device.

The liquid crystal projector is representative of those optical apparatus. In the liquid crystal projector, an optical image (image light) is formed by a liquid crystal panel that modulates an optical beam output from a light source according to image information, and the image light is projected onto a screen to display an image. Because the liquid crystal panel has a characteristic of conducting an intensity modulation on one polarization, a polarization plate (polarization element) having a function of selectively transmitting the polarized light is arranged at each of an input side and an output side.

In recent years, in order to downsize the liquid crystal projector and increase the brightness of the projected image, a light density on the liquid crystal panel is increased, and for the purpose of dealing with an increase in the light density, the polarization element excellent in tolerance to heat and light is desirable. From this viewpoint, for example, a wire grid polarization element made of inorganic material is suitable for the tolerance to heat and light. However, the wire grid polarization element is prepared during a process of shaping a metal film into a wire with the use of a semiconductor lithography technique, and is therefore generally expensive as compared with the polarization element using an organic polymer film. Also, for example, in the liquid crystal projector, it is general that a reflective mirror is installed in an optical path extending from the light source to the polarization element. If an optical device having both functions of the reflective mirror and the polarization element can be provided, the number of components is reduced to enable the cost reduction. Japanese Unexamined Patent Application Publication No. 2011-81154 discloses the optical device having both functions of the wave plate and the reflective mirror, but providing no function of the polarization selection.

An object of the present invention is to provide a novel optical device having both functions of the reflective mirror and the polarization element.

The above and other objects and novel features of the present invention will become apparent from the description of the present specification and the attached drawings.

A typical outline of the present invention disclosed in the present specification will be described in brief below.

According to one typical embodiment, there is provided an optical device including an irregular configuration portion with a periodic structure to which an electromagnetic wave is input, in which in first and second faces configuring surfaces of the irregular configuration portion, a surface roughness of the first face farther from an input side of the electromagnetic wave is rougher than the surface roughness of the second face closer to the input side of the electromagnetic wave.

According to another typical embodiment, there is provided an optical device including: an irregular configuration portion having a periodic structure to which an electromagnetic wave is input; and an absorption layer that is disposed in a lower layer of the irregular configuration portion, and absorbs the electromagnetic wave.

According to still another typical embodiment, there is provided a method for manufacturing an optical device, comprising the steps of: (a) preparing a substrate; (b) forming an irregular configuration portion with a periodic structure on a surface of the substrate; and (c) forming a metal film reflecting a shape of the irregular configuration portion, on the substrate on which the irregular configuration portion is formed, through a film forming technique having a directivity.

The advantageous effects obtained by the typical features of the present invention disclosed in the present application will be described in brief below.

There can be provided the optical device having both functions of the reflective mirror and the polarization element.

### BRIEF DESCRIPTION OF THE DRAWINGS

FIG. 1 is a perspective view illustrating a schematic configuration of a transmission optical device with a wire grid structure formed of a metal thin line structure;

FIG. 2 is a diagram illustrating a mechanism in which a TM polarized light is transmitted through a wire grid structure;

FIG. 3 is a diagram illustrating a mechanism in which the TE polarized light is reflected by the wire grid structure;

FIG. 4 is a perspective view illustrating a schematic configuration of a reflection polarization element according to a first embodiment of the present invention;

FIG. 5 is a diagram illustrating a mechanism that can realize the reflection polarization element;

FIG. 6A is a diagram illustrating an example of a polarization state of an incident light that is input to the reflection polarization element in the first embodiment;

FIG. 6B is a diagram illustrating a polarization state of a reflected light reflected from the reflection polarization element;

FIG. 7 is a diagram illustrating one calculation model of the reflection polarization element having a random surface configuration;

FIG. 8 is a diagram illustrating another calculation model of the reflection polarization element having a random surface configuration;

FIG. 9 is a diagram illustrating still another calculation model of the reflection polarization element having a random surface configuration;

FIG. 10 is a diagram illustrating yet still another calculation model of the reflection polarization element having a random surface configuration;

FIGS. 11A to 11D are diagrams illustrating results obtained by calculating a relationship between the respective reflectances of TE polarized lights and TM polarized lights of the reflection polarization elements illustrated in FIGS. 7 to 10, and the standard deviation of a random surface;

FIG. 12 is a diagram illustrating a relationship between a polarization contrast ratio and a surface roughness of the reflection polarization element according to the first embodiment;

FIGS. 13A to 13C are diagrams illustrating results of measuring the spectral reflectivity of the reflection polarization element when a height of the wire grid structure is 120 nm, 150 nm, and 180 nm;

FIG. 14 is a cross-sectional view illustrating a process for manufacturing the optical device according to the first embodiment;

FIG. 15 is a cross-sectional view illustrating a process for manufacturing the optical device subsequent to FIG. 14;

FIG. 16 is a cross-sectional view illustrating a process for manufacturing the optical device subsequent to FIG. 15;

FIG. 17 is a cross-sectional view illustrating a process for manufacturing the optical device subsequent to FIG. 16;

FIG. 18 is a cross-sectional view illustrating a process for manufacturing the optical device according to the first embodiment;

FIG. 19 is a cross-sectional view illustrating a process for manufacturing the optical device subsequent to FIG. 18;

FIG. 20 is a cross-sectional view illustrating a process for manufacturing the optical device subsequent to FIG. 19;

FIG. 21 is a cross-sectional view illustrating a process for manufacturing the optical device subsequent to FIG. 20;

FIG. 22 is a diagram illustrating an example of a cross-section SEM photograph of the reflection polarization element manufactured in a manufacturing method according to the first embodiment;

FIG. 23 is a cross-sectional view illustrating a schematic configuration of a reflection polarization element according to a second embodiment;

FIG. 24 is a diagram illustrating results of calculating a wavelength dependency of a reflectance of the reflection polarization element according to the second embodiment;

FIG. 25 is a cross-sectional view illustrating a process for manufacturing an optical device according to a second embodiment;

FIG. 26 is a cross-sectional view illustrating a process for manufacturing the optical device subsequent to FIG. 25;

FIG. 27 is a schematic view illustrating an optical system of a liquid crystal projector according to a third embodiment;

FIG. 28 is a schematic view illustrating an optical system of a liquid crystal projector in a related art;

FIG. 29 is a schematic view illustrating a configuration of an optical device (half-wavelength plate) disclosed in a related art document;

FIG. 30A is a diagram illustrating a case in which a TE polarized light is input to the optical device in the related art document; and

FIG. 30B is a diagram illustrating a reflected light from the optical device disclosed in the related art document.

### DETAILED DESCRIPTION OF THE PREFERRED EMBODIMENTS

The following embodiments are divided into a plurality of sections and embodiments, when necessary for the sake of convenience. Therefore, unless clearly indicated otherwise, the divided sections or embodiments are not irrelevant to one another, but one section or embodiment has a relation of modifications, details and supplementary explanations to some or all of the other embodiments.

In addition, in the following embodiments, when the number (including count, figure, amount, and range) of the components is mentioned, the number of components is not limited to a specific number and may be greater than, less than or equal to the specific number, unless clearly specified otherwise and definitely limited to the specific number in principle.

Furthermore, there is no need to say that, in the following embodiments, the components (including component steps, etc.) are not always essential, unless clearly specified otherwise and considered to be definitely essential in principle.

Similarly, when shapes and positional relationships, etc. of the components are mentioned in the following embodiments, the components will have shapes substantially analogous or similar to their shapes or the like, unless clearly defined otherwise and considered not to be definite in principle. This is applied likewise to the above-described numerical values and ranges as well.

In addition, in all the drawings for explaining the embodiments, the same components are indicated by the same reference numerals in principle, and so a repeated description thereof will be omitted. Also, hatching may be used even in plan views to make it easy to read the drawings.

### First Embodiment

Hereinafter, a first embodiment will be described with reference to a uniform coordinate system having an x-axis and a z-axis on a paper plane. Lights in a polarization direction are called “TE polarized light” and “TM polarized light”. The TE polarized light represents a light having an oscillating component of an electric field in a y-direction, and the TM polarized light represents a light having the oscillating component of the electric field in an x-direction. As a numerical solution of the Maxwell equations describing an electromagnetic wave, an FDTD (finite difference time domain) method is used.

A refractive index of a metal or a semiconductor material is referred to Palik handbook (Palik E. D. (ed.) (1991) Handbook of Optical Constants of Solids II. Academic Press, New York.) unless it is explicitly stated otherwise.

In particular, a technical concept in the first embodiment can be widely applied to the electromagnetic wave described in the Maxwell equations. However, in particular, a light (visible light) which is one type of the electromagnetic wave will be described as an example.

### <Technique Studied by the Present Inventors>

First, before the technical concept of the first embodiment is described, a technical premise (technique studied by the present inventors) coming to conceive the present invention will be described. Thereafter, problems with the technical premise will be described. Then, the technical concept of the first embodiment devised to solve the problems with the technical premise will be described.

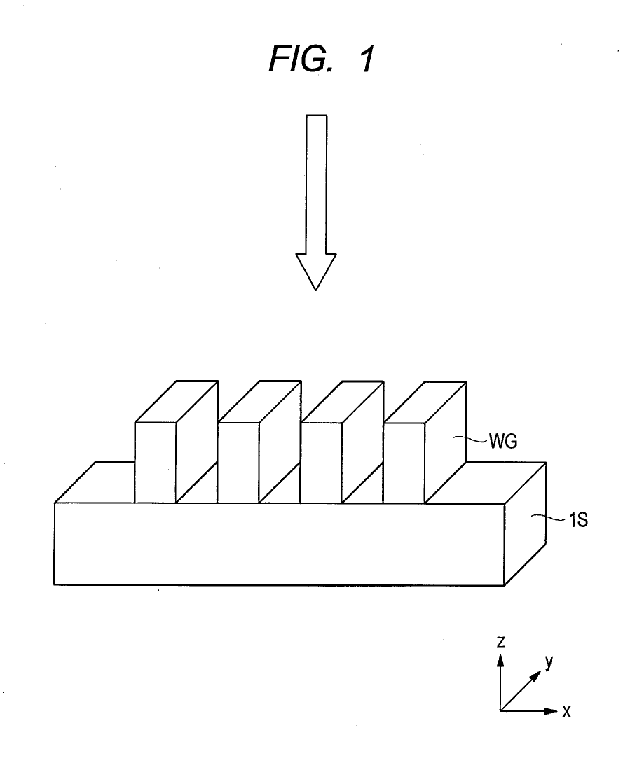

FIG. 1 is a perspective view illustrating a schematic configuration of a transmission optical device with a wire grid structure formed of a metal thin line structure. Referring to FIG. 1, in a transmission optical device of the wire grid structure, a wire grid structure WG formed of an irregular configuration portion having a periodic structure is formed on a substrate 1S formed of, for example, a glass substrate, a quartz substrate, or a plastic substrate. Specifically, as illustrated in FIG. 1, the wire grid structure WG represents a metal pectinate structure in which metal thin lines extending in the y-direction are arranged at given intervals in the x-direction, and in other words, the wire grid structure WG is formed of the irregular configuration portion in which a plurality of the metal thin lines is periodically arranged at the given intervals.

When the transmission optical device with the wire grid structure WG of the above type receives a light (electromagnetic wave) including a large number of polarized lights from an upper side of the paper plane (plus direction of the Z-axis), the transmission optical device can transmit only a polarized light that is polarized in a specific direction from a lower side of the substrate 1S. That is, the transmission optical device with the wire grid structure WG functions as a polarization element (polarization plate). Hereinafter, this mechanism (operation principle) will be described in brief with reference to the accompanying drawings.

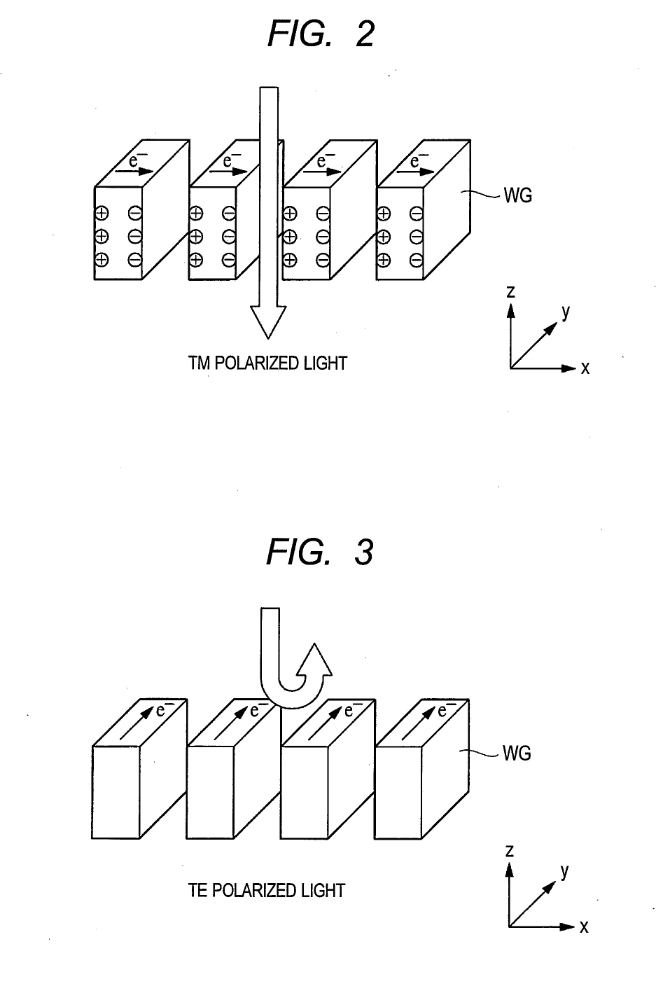

First, as illustrated in FIG. 2, when the TM polarized light whose oscillating direction of the electric field is the x-axial direction is input to the optical device, free electrons within the metal lines configuring the wire grid structure WG are gathered on one side of the metal thin lines according to the oscillating direction of the electric field, thereby allowing the individual metal thin lines to polarize. Thus, when the TM polarized light is input to the optical device, since an interior of the metal thin lines merely polarize, the TM polarized light pass through the wire grid structure WG, and reaches the substrate 1S. In this situation, because the substrate 1S is also transparent, the TM polarized light is also transmitted through the substrate 1S. As a result, the TM polarized light is transmitted through the wire grid structure WG and the substrate 1S.

On the other hand, as illustrated in FIG. 3, the TE polarized light whose oscillating direction of the electric field is the y-axial direction is input to the optical device, free electrons within the metal lines can oscillate without being restricted by side walls of the metal thin lines according to the oscillating direction of the electric field. This means that the same phenomenon as that when the light is input to a continuous metal film occurs even when the TE polarized light is input to the wire grid structure WG. Accordingly, when the TE polarized light is input to the wire grid structure WG, the TE polarized light is reflected in the same manner as that when the light is input to the continuous metal film. In this situation, when a thickness of the metal thin lines in a z-direction is thicker than a skin depth where the light can enter the metal, the wire grid structure WG has a polarization separation function high in the separation performance (extinction ratio) for transmitting the TM polarized light and reflecting the TE polarized light.

From the above fact, when the transmission optical device having the wire grid structure WG has a function of transmitting only the polarized light that has been polarized in a specific direction, when receiving, for example, a light including a variety of polarized lights. This represents that the transmission optical device having the wire grid structure WG functions as the polarization element (polarization plate).

A typical example of the optical apparatuses is a liquid crystal projector. The liquid crystal projector has a liquid crystal panel for forming an optical image (image light). The liquid crystal panel has a characteristic for subjecting one polarization to intensity modulation, and therefore a polarization plate (polarization element) having a function of selectively transmitting the polarized light is arranged on each of an input side and an output side thereof. Accordingly, for example, as the polarization plate configuring the liquid crystal projector, the above-mentioned transmission optical device having the wire grid structure WG can be used.

In particular, in order to downsize the liquid crystal projector, and increase the brightness of a projection image, a light density on the liquid crystal panel is increased, and as the polarization element that deals with the increased light density, the polarization element excellent in tolerance to heat and light is desirable. In this regard, for example, the transmission optical device having the wire grid structure WG made of an inorganic material is suitable for the increased light density. However, this transmission optical device is prepared in a process of processing the metal film into a wire shape (metal thin film shape) with the use of a semiconductor lithography technique, resulting in such a problem that this transmission optical device is generally expensive as compared with the polarization element using an organic polymer film.

In this regard, for example, in the liquid crystal projector, it is general to locate a reflective mirror in an optical path extending from a light source to the polarization element. It is conceivable that if an optical device having both functions of the reflective mirror and the polarization element can be provided, the number of parts is reduced, and the cost reduction is enabled. That is, if the optical device having both functions of the reflective mirror and the polarization element can be provided, there can be provided the optical device that is excellent in the tolerance to heat and light, and also contributes to a reduction in the costs. Under the circumstances, according to the first embodiment, there is provided the reflection polarization element having both functions of the reflective mirror and the polarization element as the optical device having the wire grid structure WG. Hereinafter, a description will be given of the technical concept of the first embodiment devising this configuration.

### (Features of the First Embodiment)

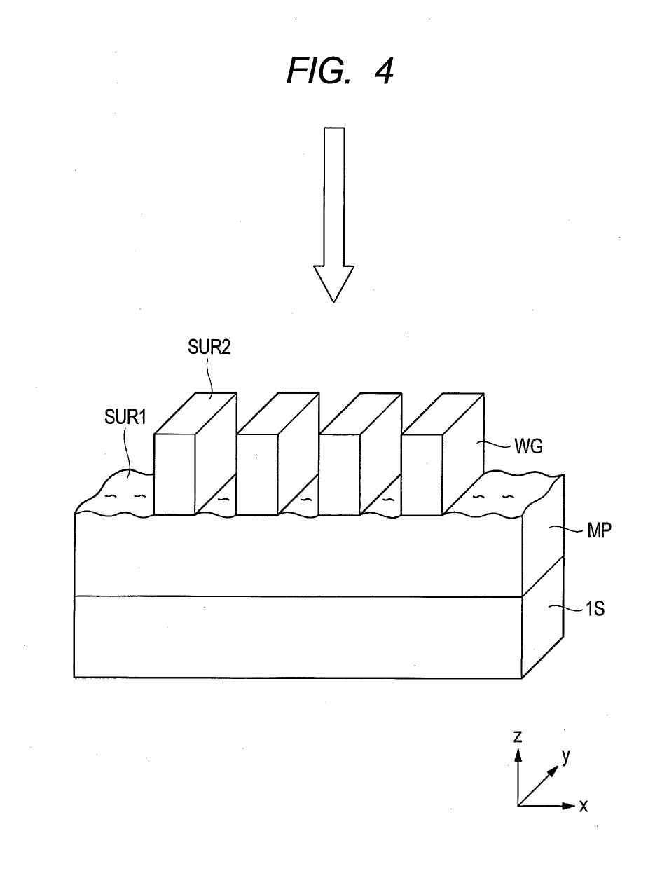

FIG. 4 is a perspective view illustrating a schematic configuration of the reflection polarization element according to the first embodiment. Referring to FIG. 4, in the reflection polarization element according to the first embodiment, a reflective mirror portion MP formed of, for example, an aluminum film is formed on the substrate 1S formed of, for example, a glass substrate, a quartz substrate, a plastic substrate, or a silicon substrate. The wire grid structure WG formed of an irregular configuration portion having a periodic structure is formed on the reflective mirror portion MP. Specifically, as illustrated in FIG. 4, the wire grid structure WG is configured by a metal pectinate structure in which metal thin lines extending in the y-direction are arranged at given intervals in the x-direction.

The feature of the first embodiment resides in that a surface roughness of a surface SUR1 of the reflective mirror portion MP is rougher than the surface roughness of a surface SUR2 of the wire grid structure WG. In other words, the feature of the first embodiment resides in that the surface roughness of a bottom surface (surface SUR1) of the irregular configuration portion is rougher than the surface roughness of an upper surface (surface SUR2) of the irregular configuration portion configuring the wire grid structure WG. Further, in other words, it can be said that, in a first surface and a second surface of the irregular configuration portion configuring the wire grid structure WG, the surface roughness of the first surface (surface SUR1) farther from the input side of a light (electromagnetic wave) is rougher than the surface roughness of the second surface (surface SUR2) closer to the input side of the light (electromagnetic wave). As a result, according to the first embodiment, the reflection polarization element can be realized. Hereinafter, a mechanism that can realize the reflection polarization element according to the above-mentioned feature of the first embodiment will be described with reference to the accompanying drawings.

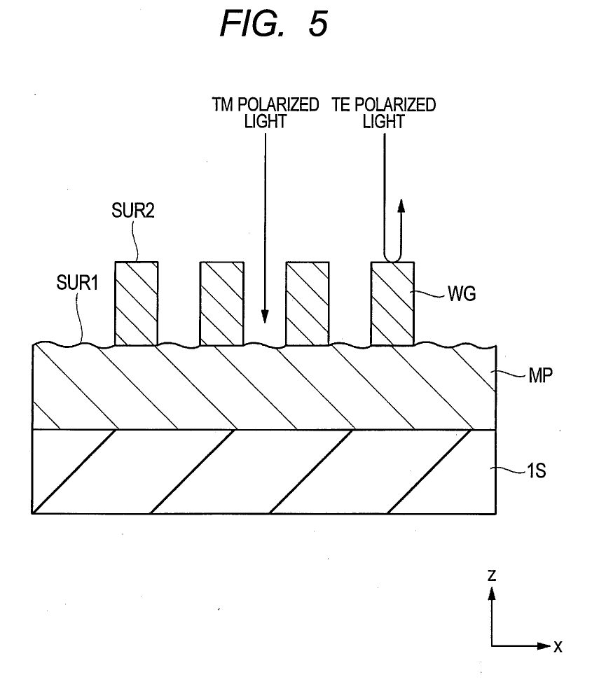

FIG. 5 is a diagram illustrating a mechanism that can realize the reflection polarization element. Referring to FIG. 5, when the TE polarized light whose oscillating direction of the electric field is the y-direction is first input to the optical device, the TE polarized light is reflected on the upper surface (surface SUR2) of the wire grid structure WG by the same mechanism as the mechanism described in FIG. 3. On the other hand, when the TM polarized light whose oscillating direction of the electric field is the x-direction is input to the optical device, the TM polarized light passes through the wire grid structure WG, and reaches the bottom surface (surface SUR1) of the wire grid structure WG by the same mechanism as the mechanism described in FIG. 2.

In this example, the surface roughness of the bottom surface (surface SUR1) of the wire grid structure WG is rougher than the surface roughness of the upper surface (surface SUR2) of the wire grid structure WG. That the surface roughness is rough represents that the randomness of the surface is large. The surface whose randomness is larger is represented by the superposition of configurations of various frequencies, and therefore it is conceivable that the surface having the larger randomness potentially includes the configurations of a large number of different frequencies. From this fact, there is a high possibility that the surface SUR1 having the larger randomness includes a configuration having the same frequency as the frequency of the TM polarized light that has reached the bottom surface (surface SUR1) of the wire grid structure WG.

As a result, it is conceivable that a resonance absorption of the TM polarized light occurs in the bottom surface (surface SUR1) of the wire grid structure WG. When the resonance absorption of the TM polarized light occurs, free electrons flow into the surface SUR1, and a Joule heat is generated by allowing the free electrons to flow thereinto. That is, when the resonance absorption of the TM polarized light occurs in the bottom surface (surface SUR1) of the wire grid structure WG, an energy of the TM polarized light is consumed by the Joule heat. For that reason, the reflectance of the TM polarized light from the bottom surface (surface SUR1) of the wire grid structure WG is lessened. Further, when the TM polarized light is input to the surface SUR1 having the rough surface roughness, a phase is disturbed to cause the scattering (diffused reflection) of the TM polarized light to be liable to occur. As a result, the ratio of the TM polarized light that is regularly reflected is also lessened.

In the present specification, the reflectance (regular reflection) represents a ratio of the light intensity of the reflected light having an output angle equal to an input angle of the incident light to the light intensity of the incident light.

From the above fact, the reflection polarization element according to the first embodiment has a function of reflecting only the polarized light that has been polarized in a specific direction, when receiving, for example, a light including a variety of polarized lights. This represents that the reflection optical device according to the first embodiment functions as the reflection polarization element (polarization plate).

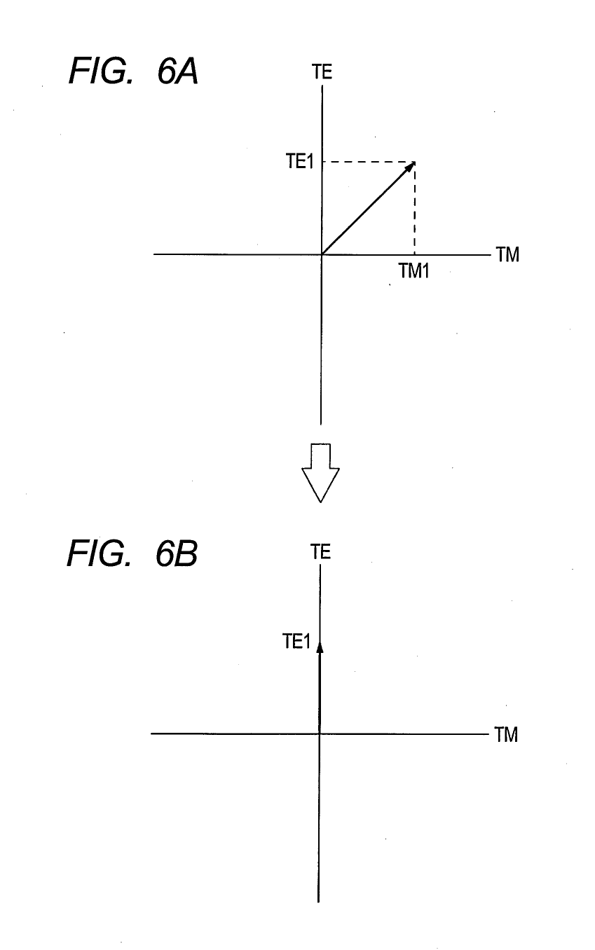

Specifically, a function of the reflection polarization element according to the first embodiment will be described. FIG. 6A is a diagram illustrating an example of a polarization state of the incident light that is input to the reflection polarization element in the first embodiment. As illustrated in FIG. 6A, the incident light represents a linearly polarized light including the TM polarized light and the TE polarized light. For example, a component of the TM polarized light is represented by TM1, and a component of the TE polarized light is represented by TE1. FIG. 6B is a diagram illustrating a polarization state of the reflected light reflected from the reflection polarization element after the incident light of this polarization state has been input to the reflection polarization element of the first embodiment.

In the reflection polarization element according to the first embodiment, as illustrated in FIG. 5, the TE polarized light is reflected while the TM polarized light is absorbed. From this fact, in the reflected light reflected from the reflection polarization element according to the first embodiment, as illustrated in FIG. 6B, the component of the TE polarized light is TE1 while the component of the TM polarized light becomes substantially zero. That is, the reflected light reflected from the reflection polarization element according to the first embodiment is substantially the TE polarized light.

From the above fact, according the reflection polarization element of the first embodiment, the reflected light including substantially only the TE polarized light among the incident light including the TE polarized light and the TM polarized light can be reflected. Therefore, it is found that the reflection polarization element according to the first embodiment functions as the polarization element (polarization plate). According to the reflection polarization element of the first embodiment, the optical device having both functions of the reflective mirror and the polarization element can be realized. Therefore, there can be provided the optical device that is excellent in the tolerance to heat and light, and also contributes to a reduction in the costs.

### <Verification of Usability of Technical Concept According to the First Embodiment>

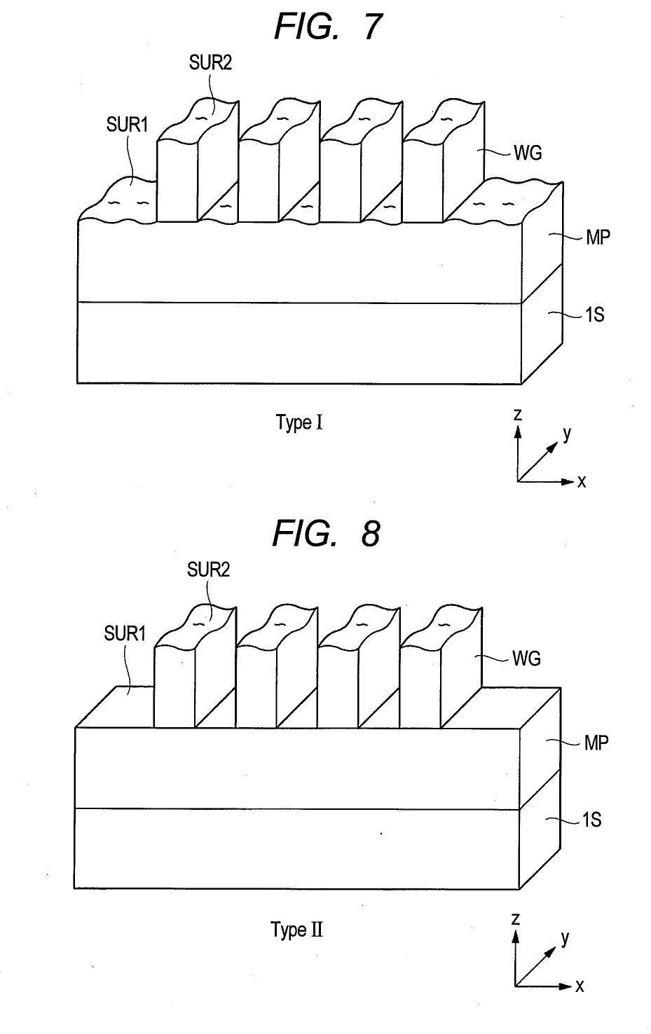

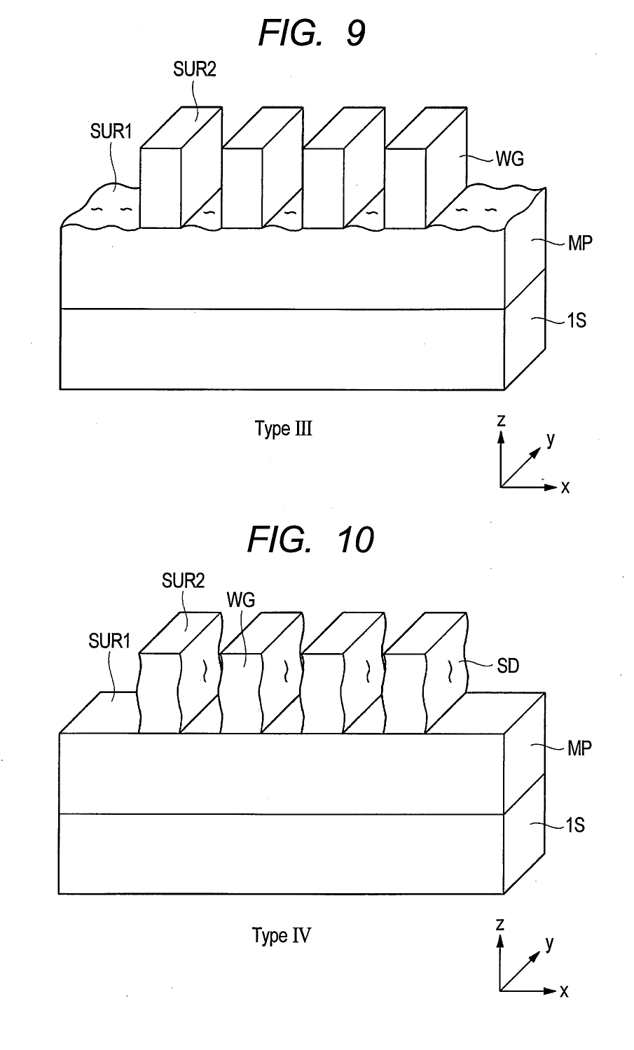

Subsequently, a description will be given of the verification results of usability of the technical concept according to the first embodiment. FIGS. 7 to 10 are diagrams illustrating a calculation model of the reflection polarization element having the random surface configuration. FIG. 7 illustrates one model (Type I) having the same random surface on the upper surface (surface SUR2) and the bottom surface (surface SUR1) of the wire grid structure WG. FIG. 8 illustrates another model (Type II) having the random surface on only the upper surface (surface SUR2) of the wire grid structure WG. FIG. 9 illustrates still another model (Type III) having the random surface on only the bottom surface (surface SUR1) of the wire grid structure WG. FIG. 10 illustrates yet still another model (Type IV) having the random surfaces on only side walls of the wire grid structure WG.

In this example, a cycle (x-direction) of the wire grid structure WG is set to 200 nm, a width of each convex of the wire grid structure WG is set to 100 nm, and a height of the convex of the wire grid structure WG (a height between the bottom surface of each concave and the upper surface of each convex) is set to 100 nm. Also, the incident light input from above of the paper plane assumes a light including the TE polarized light and the TM polarized light, and a wavelength of the incident light is set to 460 nm. A thickness of the reflective mirror portion MP is set to 200 nm, a material of the substrate 1S is silicon oxide (SiO₂), and a metal material of the reflective mirror portion MP and the wire grid structure WG is aluminum (Al).

Under the above conditions, after the electromagnetic field distribution of the reflected lights of the TE polarized light and the TM polarized light has been obtained through an FDTD method, the reflectance is calculated as a zero-order diffracted light with the use of an equivalence theorem. Mesh sizes are 5 nm in all of the x-direction, the y-direction, and the z-direction. The randomness of the surface conforms to a normal distribution, and a relationship between the reflectance and the standard deviation of each random surface illustrated in FIGS. 7 to 10 while changing the standard deviation.

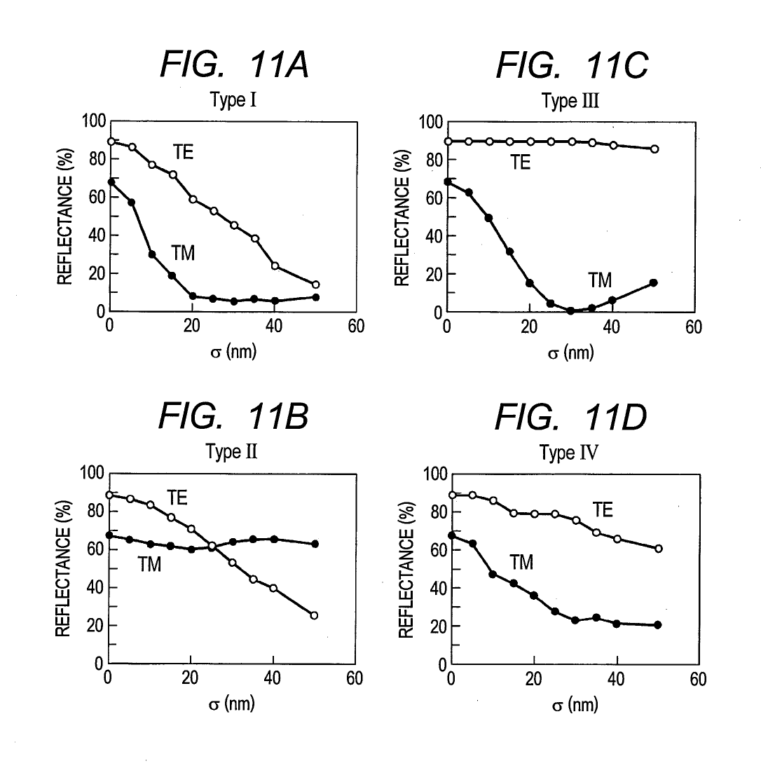

FIGS. 11A to 11D illustrate results obtained by calculating relationships between the respective reflectances of the TE polarized lights and the TM polarized lights of the reflection polarization elements of Type I to Type IV illustrated in FIGS. 7 to 10, and the standard deviations (σ) of the random surfaces. Specifically, FIG. 11A illustrates results obtained by calculating relationships between the respective reflectances of the TE polarized light and the TM polarized light of the reflection polarization element of Type I, and the standard deviations (σ) of the random surface. FIG. 11B illustrates results obtained by calculating relationships between the respective reflectances of the TE polarized light and the TM polarized light of the reflection polarization element of Type II, and the standard deviations (σ) of the random surface. FIG. 11C illustrates results obtained by calculating relationships between the respective reflectances of the TE polarized light and the TM polarized light of the reflection polarization element of Type II, and the standard deviations (σ) of the random surface. FIG. 11D illustrates results obtained by calculating relationships between the respective reflectances of the TE polarized light and the TM polarized light of the reflection polarization element of Type II, and the standard deviations (σ) of the random surface. In FIGS. 11A to 11D, the axis of abscissa represents the standard deviation (a) of the random surface, and the axis of ordinate represents the reflectance.

As illustrated in FIGS. 11A to 11D, it is found that in each of the reflection polarization elements of Type I to Type IV, the reflectance is different between the TE polarized light and the TM polarized light. In particular, in the reflection polarization element of Type III in FIG. 11C corresponding to the first embodiment, it is found that there is obtained a large polarization contract ratio that the reflectance of the TE polarized light is 85% or larger, and the reflectance of the TM polarized light is 1% or smaller under the condition where the standard deviation (a) of the random surface is about 30 nm. That is, it is found that the reflection polarization element of Type III in FIG. 11C corresponding to the first embodiment has the usability excellent as the polarization plate. That is, in the reflection polarization element according to the first embodiment, the TE polarized light is reflected on the upper surface (surface SUR2) of the wire grid structure WG, and the TM polarized light reaches the bottom surface (surface SUR1) of the wire grid structure WG.

In this situation, in the reflection polarization element of Type III in FIG. 11C corresponding to the first embodiment, because the random surface is provided on only the bottom surface (surface SUR1) of the wire grid structure WG. Therefore, when the TM polarized light is reflected on the bottom surface (surface SUR1) of the wire grid structure WG, a scattering effect caused by disturbing the phase and a resonance absorption effect caused by a microstructure develop at the same time. As a result, it is conceivable that the regular reflectance of the TM polarized light is lessened. With the mechanism thus configured, according to the reflection polarization element of the first embodiment, it is found that the large contrast can be obtained between the reflectance of the TE polarized light and the reflectance of the TM polarized light.

From the above fact, it is found that the feature of the first embodiment resides in that, in the first surface and the second surface of the irregular configuration portion configuring the wire grid structure WG, the surface roughness of the first surface (surface SUR1) farther from the input side of the light is rougher than the surface roughness of the second surface (surface SUR2) closer to the input side of the light. Further, when this feature is specifically described, the feature of the first embodiment resides in that when the surface roughness is represented by the standard deviation in the normal distribution, a first standard deviation corresponding to the surface roughness of the first surface (surface SUR1) is larger than a second standard deviation corresponding to the surface roughness of the second surface (surface SUR2). More specifically, it is desirable that the first standard deviation is a digit of several tens nm, and the second standard deviation is a digit of several nm.

Further, the feature of the first embodiment is phenomenologically described. The basic technical concept of the first embodiment resides in that if the light including the TM polarized light and the TE polarized light having the polarization direction orthogonal to that of the TM polarized light is input to the reflection polarization element of the first embodiment, in the first surface and the second surface of the irregular configuration portion configuring the wire grid structure WG, the first surface (surface SUR1) farther from the input side of the light absorbs the TM polarized light, and the second surface (surface SUR2) closer to the input side of the light reflects the TE polarized light.

In fact, because it is conceivable that a slight part of the TM polarized light is reflected without being absorbed by the above-mentioned first surface (surface SUR1). Therefore, the feature of the present invention resides in that when the light including the TM polarized light and the TE polarized light having the polarization direction orthogonal to that of the TM polarized light is input to the reflection polarization element, the reflectance of the TM polarized light on the first surface (surface SUR1) farther from the input side of the light is smaller than the reflectance of the TE polarized light on the second surface (surface SUR2) closer to the input side of the light. In this case, from the viewpoint of realizing the usability excellent as the polarization plate, it is desirable that the reflectance of the TM polarized light on the first surface is 1% or lower, and the reflectance of the TE polarized light on the second surface is 85% or higher.

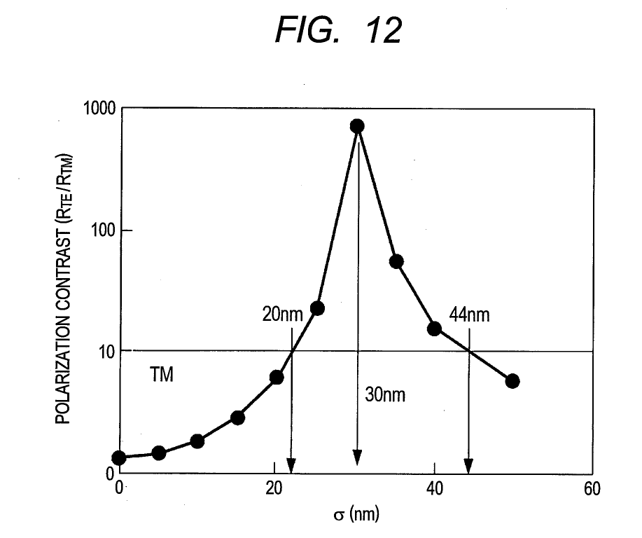

FIG. 12 illustrates calculation results representing a relationship between a polarization contrast ratio (R_{TE}/R_{TM}) of the reflection polarization element, and the surface roughness (standard deviation σ) according to the first embodiment. FIG. 12 organizes the results illustrated in FIG. 11C.

In this example, a cycle of the wire grid structure WG is set to 200 nm, and a height (height between the bottom surface of the concave and the upper surface of the convex) is set to 100 nm. Referring to FIG. 12, the axis of abscissa represents the standard deviation (a) which serves as an index of the surface roughness, and the axis of ordinate represents the polarization contrast ratio.

As illustrated in FIG. 12, it is found that a maximum polarization contrast ratio (about 800) is obtained when the standard deviation σ indicative of surface roughness of the bottom surface of the wire grid structure WG is about 30 nm. In this case, for example, if the polarization contrast ratio is 10 or larger, the function of the reflection polarization element in the first embodiment explicitly develops. From that viewpoint, referring to FIG. 12, the reflection polarization element according to the first embodiment functions as an effective polarization element when a value of the standard deviation indicative of the surface roughness of the bottom surface of the wire grid structure WG ranges from 22 nm to 44 nm. In other words, when a value of the standard deviation indicative of the surface roughness as a relative value to a typical numerical number (cycle or height) of the wire grid structure WG ranges about from 11% ( 22/200 (a value of the cycle)) to 44% ( 44/100 (a value of the height)), the remarkable effect as the polarization element develops.

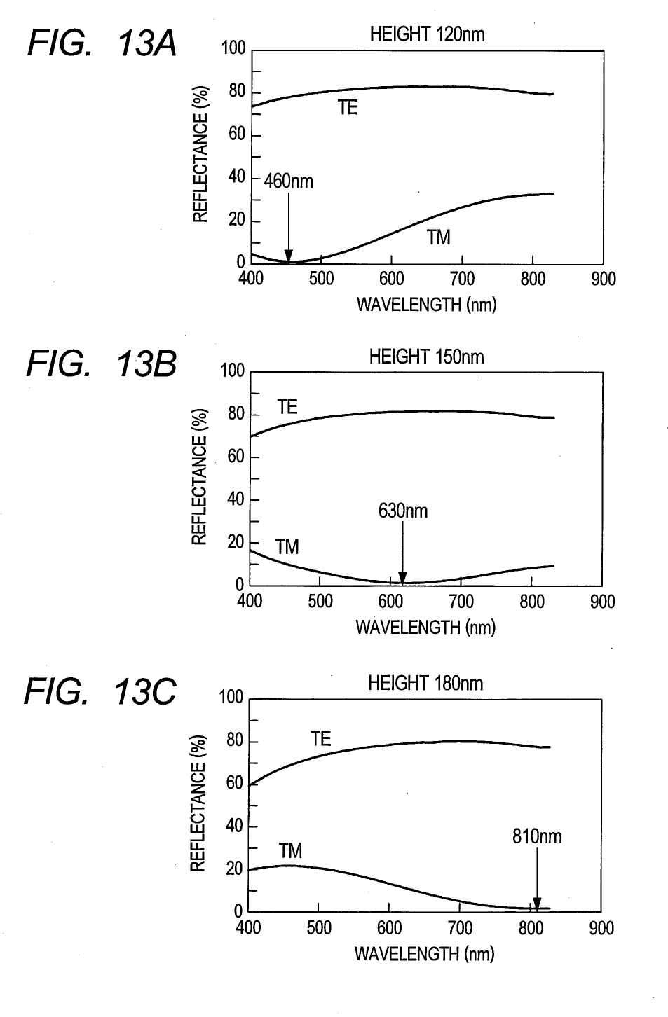

Subsequently, a description will be given of a spectral reflectivity of the reflection polarization element according to the first embodiment. FIGS. 13A to 13C are diagrams illustrating results of measuring the spectral reflectivity of the reflection polarization element according to the first embodiment. FIGS. 13A to 13C illustrate the results when the height (height between the bottom surface of the concave and the upper surface of the convex) of the wire grid structure WG is 120 nm, 150 nm, and 180 nm.

Referring to FIGS. 13A to 13C, the axis of abscissa represents a wavelength (nm) the incident light, and the axis of ordinate represents the reflectance. In this example, a spectral photometer (U4100 made by Hitachi, Ltd.) is used for measurement of the spectral reflectivity. Also, in order to separate the TE polarized light and the TM polarized light from each other for measurement of the reflectance, two Gran-Taylor prisms made by Lambert Company are each used as an analyzer and a polarizer. Like the calculation results illustrated in FIG. 11C, in each case of FIGS. 13A to 13C, a phenomenon that the reflectance of the TE polarized light becomes large, and the reflectance of the TM polarized light become small has been observed by the reflection polarization element of the first embodiment. At the same time, it is found that a wavelength at which the reflectance of the TM polarized light becomes minimized is different according to the height of the wire grid structure WG, that is, the height between the bottom surface of the concave and the upper surface of the convex in the irregular configuration portion. That is, it is found that the height of the wire grid structure WG is set to a given value, thereby enabling the wavelength at which the reflectance of the TM polarized light is minimized to be selected.

It is understood that this is because an effective height of the wire grid structure WG (height taking into consideration an effective refractive index when a light is advanced between a plurality of metal thin lines configuring the wire grid structure WG by the effect of a surface plasmon) corresponds to λ/4 (λ is a wavelength), the reflectance is minimized by the same interference effect as that of a well-known antireflective film. Therefore, in the reflection polarization element according to the first embodiment, it is desirable that, in the first surface and the second surface of the irregular configuration portion configuring the wire grid structure WG, the surface roughness of the first surface (surface SUR1) farther from the input side of the light is rougher than the surface roughness of the second surface (surface SUR2) closer to the input side of the light, and the effective height of the wire grid structure WG is set to a value corresponding to λ/4 (λ is a wavelength). In this case, the regular reflectance of the TM polarized light can be made as small as possible by the same interference effect as that of the antireflective film, in addition to the effect that the scattering effect caused by disturbing the phase due to the surface roughness and the resonance absorption effect caused by the surface roughness develop at the same time.

With the above mechanism, according to the reflection polarization element of the first embodiment, a large contrast can be obtained between the reflectance of the TE polarized light and the reflectance of the TM polarized light. As a result, according to the reflection polarization element of the first embodiment, the optical device having both functions of the reflective mirror and the polarization element can be realized. Therefore, there can be provided the optical device that is excellent in the tolerance to heat and light, and also contributes to a reduction in the costs.

As illustrated in FIG. 13A, when the height of the wire grid structure WG is 120 nm, the wavelength of the incident light at which the reflectance of the TM polarized light is minimized is 460 nm. As illustrated in FIG. 13B, when the height of the wire grid structure WG is 150 nm, the wavelength of the incident light at which the reflectance of the TM polarized light is minimized is 630 nm. Also, as illustrated in FIG. 13C, when the height of the wire grid structure WG is 180 nm, the wavelength of the incident light at which the reflectance of the TM polarized light is minimized is 810 nm. In those wavelengths, because the polarization contrast ratio (reflectance of the TE polarized light/reflectance of the TM polarized light) becomes the maximum, those wavelengths can sufficiently exert the performance of the reflection polarization element.

When the application of the first embodiment to an optical apparatus represented by the liquid crystal projector is considered, it is found that the reflection polarization element in which the height of the wire grid structure WG illustrated in FIG. 13A is 120 nm is suitable for blue (a rough wavelength ranges from 430 nm to 500 nm). Also, the reflection polarization element in which the height of the wire grid structure WG is between 120 nm (FIG. 13A) and 150 nm (FIG. 13B) is suitable for green (a rough wavelength ranges from 500 nm to 600 nm). Further, it is found that the reflection polarization element in which the height of the wire grid structure WG illustrated in FIG. 13B is 180 nm is suitable for red (a rough wavelength ranges from 600 nm to 680 nm). Further, it is found that the reflection polarization element in which the height of the wire grid structure WG illustrated in FIG. 13C is 180 nm is suitable for a near-infrared laser beam having a wavelength of 780 nm to 830 nm used in a CD player.

Thus, according to the reflection polarization element of the first embodiment, the height of the wire grid structure WG is set according to the wavelength of the incident light, to thereby make the polarization contrast ratio maximum according to the wavelength of the incident light. For that reason, according to the reflection polarization element of the first embodiment, there can be obtained an advantage that the wide application of the present invention to the optical apparatus represented by the liquid crystal projector is enabled. That is, according to the reflection polarization element of the first embodiment, there can be obtained an advantage that the application of the first embodiment to a variety of optical products having a wide wavelength band is facilitated.

In designing the reflection polarization element of the first embodiment, conditions such as a material of the metal film, a film forming method, or pitches or widths of the wire grid structure WG can be appropriately selected to obtain the suitable device characteristics on a basis that the wavelength at which the polarization contrast ratio becomes maximum can be selected according to the height of the wire grid structure WG. For example, as a material of the available metal film, a metal material in which an imaginary part of a complex refractive index is larger than a real part thereof at a use wavelength band is suitable. Silver (Ag), gold (Au), copper (Cu), and platinum (Pt) are suitable for the material of the metal film, in addition to aluminum (Al). Among those materials, aluminum (Al) is widely used because of a relatively inexpensive material.

Under the conditions where a diffracted light occurs due to the wire grid structure WG, because the large regular reflectance of the TE polarized light is not obtained by the diffraction loss caused by a primary diffracted light or a secondary diffracted light, it is desirable that the cycle of the wire grid structure WG is smaller than the wavelength of the incident light.

A description will be given of a reason that the diffraction loss caused by the primary diffracted light or the secondary diffracted light is not generated by making the cycle of the wire grid structure WG smaller than the wavelength of the incident light.

When a light is input to the wire grid structure WG having the cyclic structure, an angle of the diffracted light (reflected diffracted light) of the light reflected by the wire grid structure WG is represented by the following Expression (1).

sin θ=m×λ/PT (1)

In this expression, sin θ is a diffraction angle (angle of an interface to which a light is input with respect to a normal line), m is a diffraction order (integer), λ is a wavelength of the incident light, and PT is a cycle of the wire grid structure WG. For example, when it is assumed that the wavelength λ of the incident light is 500 nm, the cycle PT of the wire grid structure WG is 550 nm, and the diffraction order m is 1, sin θ<1 is satisfied, and the reflected diffracted light (primary diffracted light) is generated in a direction of θ=65.4°. When such a reflected diffracted light is present, a loss caused by the diffracted light occurs, and the regular reflectance is lessened. That is, when the cycle PT of the wire grid structure WG becomes larger than the wavelength λ of the incident light, the reflected diffracted light is generated, and the regular reflectance is lessened.

On the other hand, when the cycle PT of the wire grid structure WG is made smaller than the wavelength λ of the incident light, sin θ>1 is satisfied, and the reflected diffracted light is not generated. Accordingly, when the cycle PT of the wire grid structure WG is made smaller than the wavelength λ of the incident light, the diffraction loss caused by the primary diffracted light and the secondary diffracted light does not occur so that the large regular reflectance can be obtained. For that reason, it is desirable that the cycle of the wire grid structure WG is smaller than the wavelength of the incident light.

<Method for Manufacturing Optical Device according to the First Embodiment>

The optical device according to the first embodiment is configured as described above, and a method for manufacturing the optical device will be described below. In this example, a description will be given of the method for manufacturing the optical device having a structure that is equivalent to the above-mentioned optical device per se in principle, and also focusing on a viewpoint of the cost reduction.

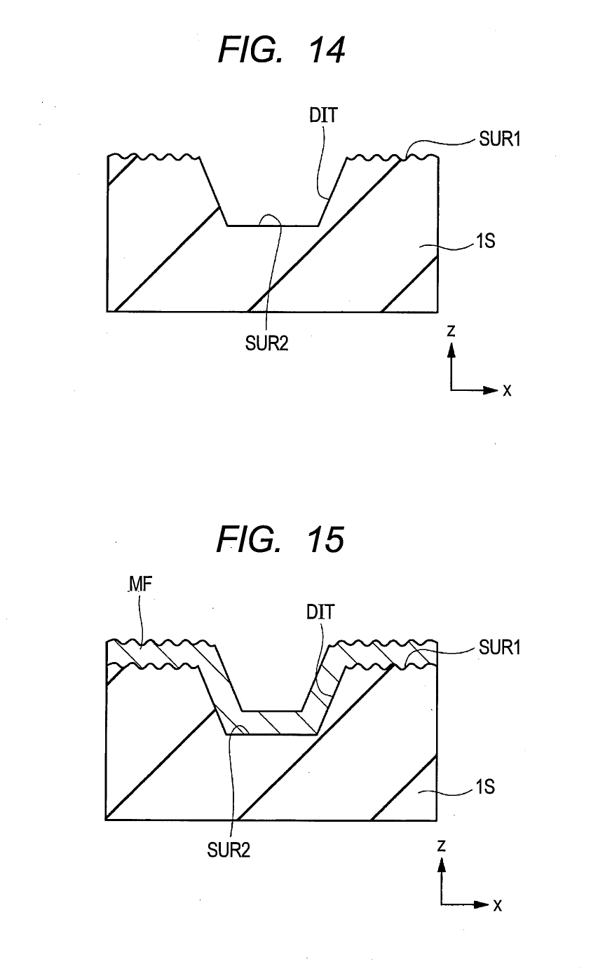

First, as illustrated in FIG. 14, the substrate 1S on which the irregular configuration portion is formed is prepared. In order to form the irregular configuration portion on the substrate 1S, there can be used, for example, an injection molding method which is applied to a CD (compact disk) or a DVD (digital video disk). That is, a transparent plastic substrate having an irregular pattern can be obtained by the injection molding method. Also, the irregular pattern can be formed on a surface of a glass substrate, a quartz substrate, or a silicon substrate by application of a nanoimpoint method.

In this example, in the first embodiment, as illustrated in FIG. 14, a process of roughening the surface roughness of the surface SUR1 of the convex is conducted. This process is, for example, enabled by preparing a stamper having a random surface directly formed through an electron beam lithography technique, or enabled by application of a surface treatment method (surface texture formation) for suppressing the reflectance of a solar cell, or a surface treatment method for suppressing a head crush of a magnetic disc. In this way, the irregular configuration portion having a groove DIT is formed on the substrate 1S, and the surface roughness of the surface SUR1 can be made rougher than the surface roughness of the surface SUR2 configuring the bottom surface of the groove DIT.

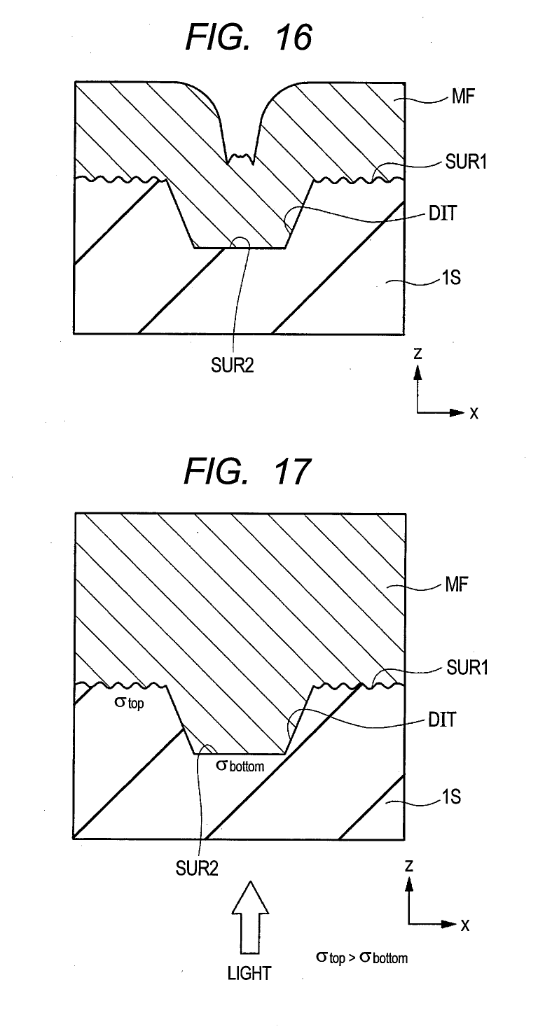

Then, as illustrated in FIG. 15, a metal film MF formed of, for example, an aluminum (Al) film is formed on a surface of the substrate 1S on which the irregular configuration portion is formed, with the use of the sputtering method. In this situation, in a state where a thickness of the metal film MF is thin, the metal film MF is formed to reflect the surface configuration of the substrate 1S. Thereafter, as illustrated in FIG. 16, the thickness of the metal film MF deposited on the substrate 1S is thickened. In the film forming technique represented by the sputtering method, metal particles are deposited on the substrate 1S with a larger motion energy not only in the z-direction, but also, in the x-direction and in the y-direction. Accordingly, as the thickness of the metal film MF deposited on the substrate 1S becomes thicker, a configuration of the metal film MF reflecting the irregular configuration portion formed on the surface of the substrate 1S is gradually smoothened. Finally, as illustrated in FIG. 17, the surface of the metal film MF is flattened regardless of the configuration of the irregular configuration portion formed on the surface of the substrate 1S. In this way, the optical device according to the first embodiment can be manufactured.

Specifically, as illustrated in FIG. 17, in the optical device according to the first embodiment, the surface roughness of the surface SUR1 of the substrate 1S is rougher than the surface roughness of the surface SUR2 of the substrate 1S. In other words, a standard deviation σₜₒₚ corresponding to the surface roughness of the surface SUR1 is sufficiently larger than a standard deviation σ_{bottom} corresponding to the surface roughness of the surface SUR2. In this case, as illustrated in FIG. 17, when the incident light is input from a lower side of the substrate 1S, the TE polarized light included in the incident light is reflected on the surface SUR2 while the TM polarized light included in the incident light is absorbed by the surface SUR1 of the substrate 1S. More strictly speaking, when the incident light is input from the lower side of the substrate 1S, the reflectance of the TM polarized light on the surface SUR1 is sufficiently smaller than the reflectance of the TE polarized light on the surface SUR2. As a result, according to the first embodiment, the reflected light including substantially only the TE polarized light can be reflected from the incident light including the TE polarized light and the TM polarized light.

Accordingly, it is found that the reflection polarization element according to the first embodiment functions as the polarization element (polarization plate). In particular, in the above-mentioned manufacturing method, the optical device can be manufactured with the low manufacturing costs because a technique generally used in a CD manufacturing technique, a manufacturing technique of the solar cell, or a magnetic disc manufacturing technique can be diverted in the above-mentioned manufacturing method.

From the above fact, according to the first embodiment, there can be provided the optical device that is excellent in the tolerance to heat and light, and also contributes to a reduction in the costs.

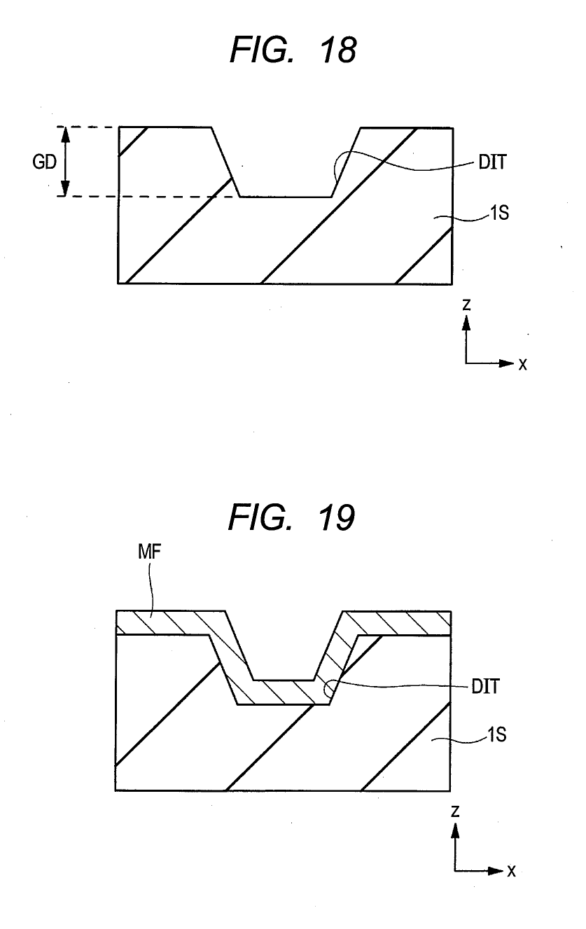

Subsequently, a description will be given of a method of manufacturing the optical device that is capable of reducing the costs. First, as illustrated in FIG. 18, the substrate 1S in which the irregular configuration portion is formed is prepared as illustrated in FIG. 18. In order to form the irregular configuration portion in the substrate 1S, the injection molding method which is applied to, for example, a CD (compact disk) or a DVD (digital video disk) can be used. That is, the transparent plastic substrate having the irregular pattern can be obtained by the injection molding method. Also, the irregular pattern can be formed on the surface of the glass substrate, the quartz substrate, or the silicon substrate by application of the nanoimprint method. In this way, the irregular configuration portion having the groove DIT is formed in the substrate 1S. A depth GD of the groove DIT is illustrated.

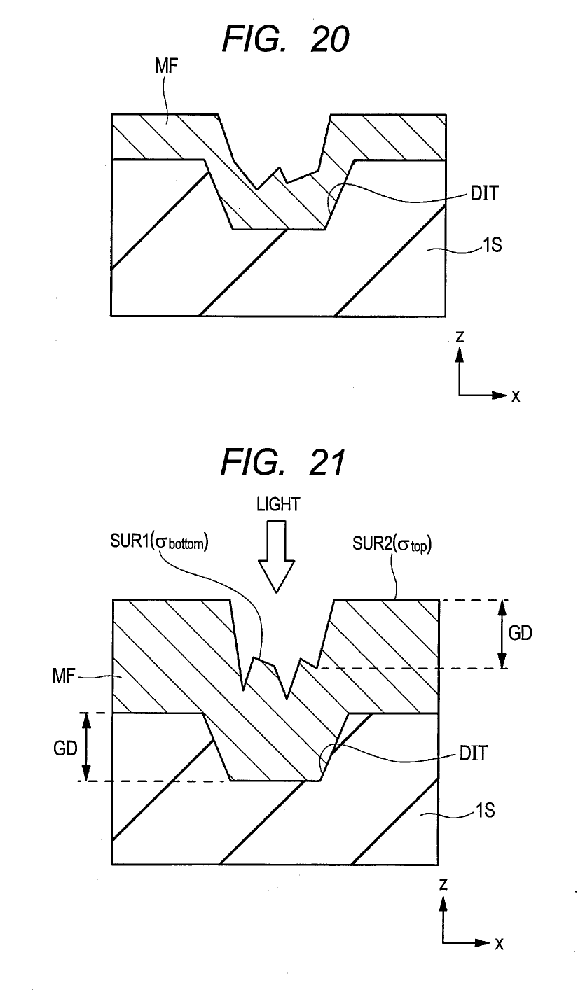

Subsequently, as illustrated in FIG. 19, the metal film MF formed of, for example, an aluminum (Al) film is formed on the substrate 1S having the groove DIT through a film forming technique in which the motion energy of the metal particles is located in the z-direction such as the electron beam evaporation technique. That is, the metal film MF is formed through the film forming technique using a particle beam high in straightness. In this case, as illustrated in FIG. 20, when the thickness of the metal film MF is thickened, metal crystal grains are deposited and grown in an area corresponding to the convex of the substrate 1S in a state where there is no inhibitory element because a peripheral portion thereof is vacuum. On the other hand, in the area corresponding to the concave of the substrate 1S, a crystal orientation growing by a grain boundary of the convex where crystal that has grown ahead is restricted. As a result, as illustrated in FIG. 21, when the thickness of the metal film MF is further thickened, the surface roughness of the bottom surface of the concave is rougher than the surface roughness of the upper surface of the convex. In this situation, for example, the depth GD of the concave formed in the metal film MF can be made equal to the depth GD of the groove DIT formed in the substrate 1S.

In this way, the optical device according to the first embodiment can be manufactured. Specifically, as illustrated in FIG. 21, in the optical device according to the first embodiment, the surface roughness of the surface SUR1 of the concave of the metal film MF is rougher than the surface roughness of the surface SUR2 of the concave of the metal film MF. In other words, the standard deviation σ_{bottom} corresponding to the surface roughness of the surface SUR1 is sufficiently larger than the standard deviation σₜₒₚ corresponding to the surface roughness of the surface SUR2. In this case, as illustrated in FIG. 21, when the incident light is input from an upper side of the substrate 1S, the TE polarized light included in the incident light is reflected on the surface SUR2 of the metal film MF while the TM polarized light included in the incident light is absorbed by the surface SUR1 of the metal film MF. More strictly speaking, when the incident light is input from the upper side of the metal film MF, the reflectance of the TM polarized light on the surface SUR1 is sufficiently smaller than the reflectance of the TE polarized light on the surface SUR2.

As a result, according to the first embodiment, the reflected light including substantially only the TE polarized light can be reflected from the incident light including the TE polarized light and the TM polarized light. Accordingly, it is found that the reflection polarization element according to the first embodiment functions as the polarization element (polarization plate).

The feature of this manufacturing method resides in that there is provided a process of forming the metal film MF that reflects the configuration of the irregular configuration portion on the substrate 1S in which the irregular configuration portion is formed, through the film forming method having the directivity. In particular, as this process, there is used the film forming technique using the particle beam in which the motion energy of the metal particles is located in the thickness direction of the substrate 1S. As a result, the surface roughness of the bottom surface of the concave of the metal film MF can be made rougher than the surface roughness of the upper surface of the convex of the metal film MF. According to this film forming technique, because there is no need to specially conduct the process of roughening the surface roughness of the surface SUR1 of the concave, the costs can be further reduced. From the above fact, according to the first embodiment, there can be provided the optical device that is excellent in the tolerance to heat and light, and also contributes to a reduction in the costs.

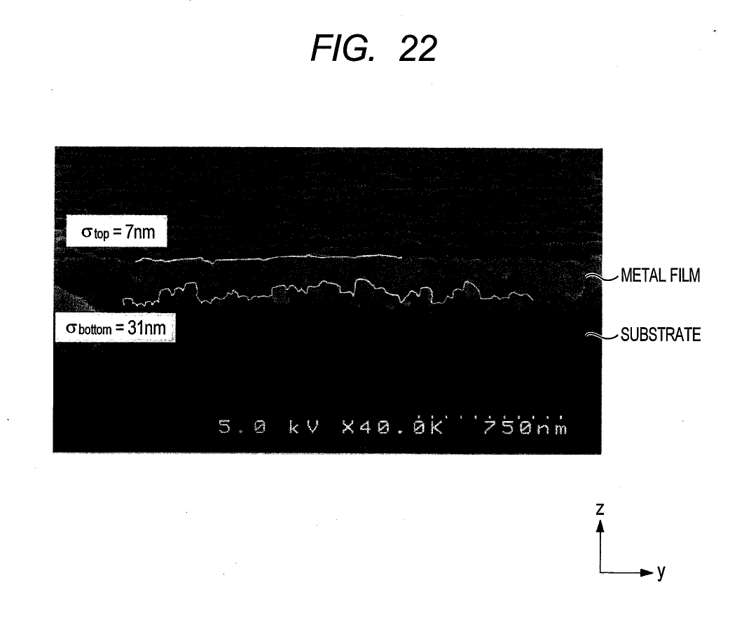

FIG. 22 illustrates an example of a cross-section SEM photograph of the reflection polarization element manufactured in a manufacturing method according to the first embodiment. In FIG. 22, a specimen is split along an extension direction (y-direction) of the wire grid structure (irregular configuration portion), and observed. The used substrate is 200 nm in pitch, 100 nm in the width of the groove, and 180 nm in the depth of the groove. The specimen is formed by transferring an irregular pattern of the wire grid structure (pectinate structure) to a quartz substrate through a glass 2P method, with the use of a silicon stamper produced by using the electron beam lithography process. Aluminum (Al) is selected as the material of the metal film, and laminated in the thickness of about 220 nm through the electron beam evaporation method. As illustrated in FIG. 22, in the prepared specimen, the standard deviation σₜₒₚ indicative of the surface roughness of the surface (convex) of the wire grid structure is 7 nm, and the standard deviation σ_{bottom} indicative of the surface roughness of the bottom surface (convex) of the wire grid structure is 31 nm.

Thus, in the method for manufacturing the reflection polarization element according to the first embodiment, it is found that the surface roughness of the surface of the concave of the metal film can be made rougher than the surface roughness of the surface of the convex of the metal film. In other words, it is found that the standard deviation σ_{bottom} corresponding to the surface roughness of the concave can be made sufficiently larger than the standard deviation σₜₒₚ corresponding to the surface roughness of the convex.

### Second Embodiment

In the first embodiment, for example, as illustrated in FIG. 4, a description is given of the example in which, in the first surface and the second surface of the irregular configuration portion configuring the wire grid structure WG, the surface roughness of the first surface (surface SUR1) farther from the input side of a light (electromagnetic wave) is rougher than the surface roughness of the second surface (surface SUR2) closer to the input side of the light (electromagnetic wave). In a second embodiment, a description will be given of an example in which a light absorbing layer is disposed on a lower layer of the wire grid structure WG.

### <Features of the Second Embodiment>

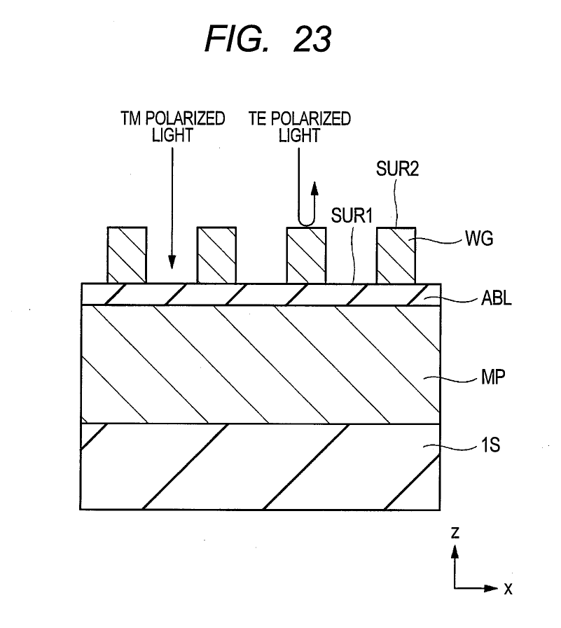

FIG. 23 is across-sectional view illustrating a schematic configuration of a reflection polarization element according to the second embodiment. Referring to FIG. 23, in the reflection polarization element according to the second embodiment, the reflective mirror portion MP formed of, for example, an aluminum film, is formed on the substrate 1S formed of, for example, a glass substrate, a quartz substrate, plastic substrate, or a silicon substrate. A light absorbing layer ABL that absorbs a light is formed on the reflective mirror portion MP, and the wire grid structure WG formed of the irregular configuration portion having the periodic structure is formed on the light absorbing layer ABL. Specifically, the wire grid structure WG is configured by a metal pectinate structure in which metal thin lines extending in the y-direction are arranged at given intervals in the x-direction. The feature of the second embodiment resides in that the light absorbing layer ABL is disposed between the reflective mirror portion MP and the wire grid structure WG. As a result, according to the second embodiment, the irregular configuration portion can be realized.

In this example, the light absorbing layer ABL can be formed of a metal oxide film or a metal nitride film. Specifically, the light absorbing layer ABL can be formed of, for example, a chromic oxide film, a titanium oxide film, tantalum oxide film, a molybdenum oxide, a cobalt oxide film, an iron oxide film, a vanadium oxide film, a chromic oxide film, a titanium nitride film, a tantalum nitride film, a molybdenum nitride film, a cobalt oxide film, an iron nitride film, a vanadium nitride film, or a silicon nitride film. It is desirable that the light absorbing layer ABL is made of a material which is an inorganic material thin film having a light absorbing property, and 300° C. or higher from the viewpoint of ensuring the stability of the use environment.

In the reflection polarization element according to the second embodiment, as each metal material of the reflective mirror portion MP and the wire grid structure WG, an aluminum (Al) film is used. However, the material is not limited to this, but Silver (Ag), gold (Au), copper (Cu), or platinum (Pt), may be used as in the first embodiment. Among those materials, aluminum (Al) is widely used because of a relatively inexpensive material.

Also, in the reflection polarization element according to the second embodiment, the wire grid structure WG (pectinate structure) is set to be 160 nm in pitch, 80 nm in width, and 80 nm in height. Further, as the light absorbing layer ABL, a chromic oxide (Cr₂O₃) film (complex refractive index is 2.67+0.29i) is used, and set to be 40 nm in thickness. Also, the reflective mirror portion MP formed in the lower layer of the light absorbing layer ABL is formed of an aluminum film which is 200 nm in thickness.

Hereinafter, a mechanism that can realize the reflection polarization element by the above feature of the second embodiment will be described with reference to the drawings.

Referring to FIG. 23, when the TE polarized light whose oscillating direction of the electric field is the y-direction is first input to the reflection polarization element, the TE polarized light is reflected on the upper surface (surface SUR2) of the wire grid structure WG by the same mechanism as the mechanism described in FIG. 3. On the other hand, when the TM polarized light whose oscillating direction of the electric field is the x-direction is input to the reflection polarization element, the TM polarized light passes through the wire grid structure WG, and reaches the bottom surface (surface SUR1) of the wire grid structure WG by the same mechanism as the mechanism described in FIG. 2. In the second embodiment, the light absorbing layer ABL is formed in the lower surface of the wire grid structure WG. With this configuration, the TM polarized light that has reached the bottom surface (surface SUR1) of the wire grid structure WG is absorbed by the light absorbing layer ABL. Strictly speaking, the light absorbing layer ABL could hardly be described as having an absorptivity of 100%. However, the reflected TM polarized light is decreased with the provision of at least the light absorbing layer ABL. That is, the reflectance of the TM polarized light from the bottom surface (surface SUR1) of the wire grid structure WG is lessened.

From the above fact, the reflection polarization element according to the second embodiment has a function of reflecting mainly the polarized light (TE polarized light) that has been polarized in a specific direction, when receiving, for example, a light including a variety of polarized lights. This represents that the reflection optical device according to the second embodiment functions as the reflection polarization element (polarization plate). In this way, according to the second embodiment, it is found that the reflection polarization element can be realized by the provision of the light absorbing layer ABL in the lower layer of the wire grid structure WG.

Similarly, in the second embodiment, a height of the wire grid structure WG and a thickness of the light absorbing layer ABL are set to respective given values, to thereby enable the reflectance of the TM polarized light to be minimized. Specifically, an effective height of the wire grid structure WG (height taking into consideration an effective refractive index when a light is advanced between a plurality of metal thin lines configuring the wire grid structure WG by the effect of a surface plasmon), and the thickness of the light absorbing layer ABL are set to correspond to λ/4 (λ is a wavelength of the incident light). As a result, the reflectance can be minimized by the same interference effect as that of a well-known antireflective film. Therefore, in the reflection polarization element according to the second embodiment, it is desirable that the light absorbing layer ABL is disposed in the lower layer of the wire grid structure WG, and the effective height of the wire grid structure WG and the effective thickness of the light absorbing layer ABL are set to correspond to λ/4 (λ is a wavelength).

In this case, the regular reflectance of the TM polarized light can be made as small as possible by the same interference effect as that of the antireflective film, in addition to the fact that the absorption effect of the TM polarized light by the light absorbing layer ABL develops. With this mechanism, in the reflection polarization element according to the second embodiment, a large contrast can be obtained between the reflectance of the TE polarized light and the reflectance of the TM polarized light. As a result, according to the reflection polarization element of the second embodiment, the optical device having both functions of the reflective mirror and the polarization element can be realized. Therefore, there can be provided the optical device that is excellent in the tolerance to heat and light, and also contributes to a reduction in the costs.

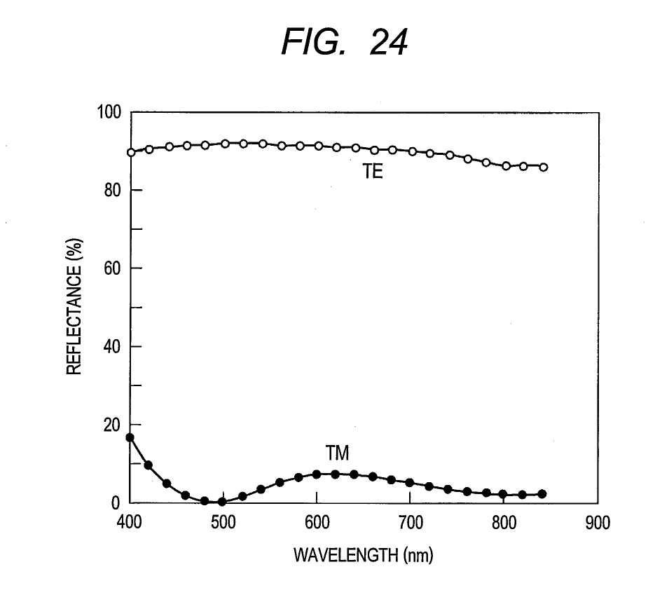

FIG. 24 illustrates results of calculating a wavelength dependency of the reflectance of the reflection polarization element according to the second embodiment. Referring to FIG. 24, the axis of abscissa represents the wavelength (nm) of the incident light, and the axis of ordinate represents the reflectance. As illustrated in FIG. 24, it is found that the reflectance of the TM polarized light is smaller than the reflectance of the TE polarized light. In other words, it is found that the reflectance of the TE polarized light is larger than the reflectance of the TM polarized light. This is because, in the second embodiment, the light absorbing layer ABL is disposed in the lower layer of the wire grid structure WG (irregular configuration portion), and therefore most of the TM polarized light transmitted through the wire grid structure WG is absorbed by the light absorbing layer ABL. Therefore, according to the second embodiment, it is found that with the provision of the light absorbing layer ABL in the lower layer of the wire grid structure WG (irregular configuration portion), characteristics desired as the reflection polarization element are obtained.

### <Method for Manufacturing Optical Device According to the Second Embodiment>

The optical device according to the second embodiment is configured as described above, and a method for manufacturing the optical device will be described below.

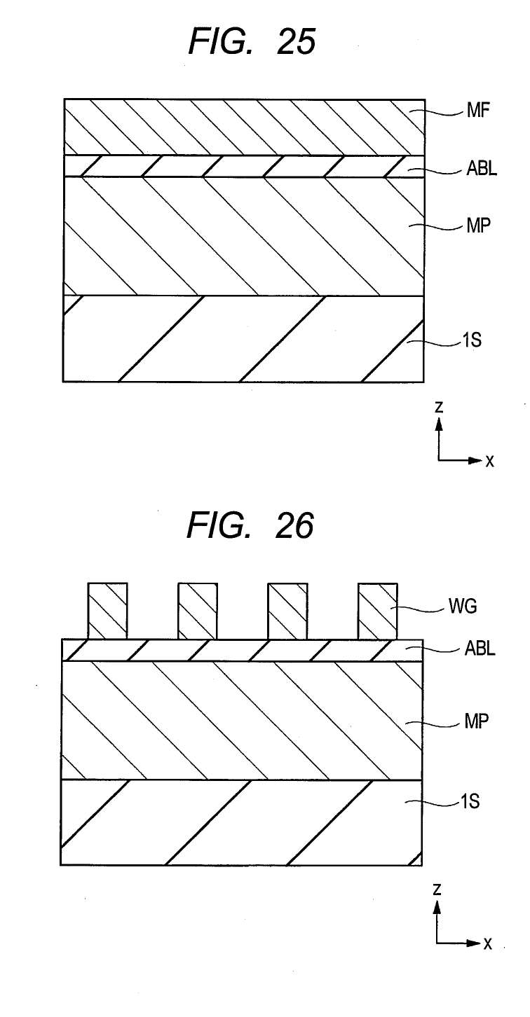

First, as illustrated in FIG. 25, the reflective mirror portion MP is formed on the substrate 1S formed of, for example, a plastic substrate, a glass substrate, a quartz substrate, or a silicon substrate. The reflective mirror portion MP is formed of, for example, an aluminum (Al) film, and can be formed, for example, with the use of the sputtering method. The light absorbing layer ABL is formed on the reflective mirror portion MP. The light absorbing layer ABL is formed of, for example, the chromic oxide film, and can be formed, for example, with the use of the sputtering method. Thereafter, the metal film MF formed of, for example, an aluminum (Al) film is formed on the light absorbing layer ABL. The metal film MF can be also formed, for example, with the use of the sputtering method. In this way, there can be formed a laminated structure in which the reflective mirror portion MP, the light absorbing layer ABL, and the reflective mirror portion MP are sequentially laminated on the substrate 1S.

Subsequently, as illustrated in FIG. 26, the metal film MF formed on an uppermost layer of the laminated structure is patterned with the use of the photolithography technique and the etching technique. The metal film MF is patterned so that a resist film remains in an area where the metal thin lines are formed. With the patterned resist film as a mask, the metal film MF is etched. As a result, the metal film MF is patterned so that the wire grid structure WG formed of the metal film MF can be formed.

In etching the metal film MF conducted in this situation, the light absorbing layer ABL formed in the lower layer of the metal film MF functions as an etching stopper. That is, the metal oxide or the metal nitride configuring the light absorbing layer ABL, and the metal film MF are generally different in etching rate from each other. Therefore, when the metal film MF is etched, the light absorbing layer ABL formed in the lower layer of the metal film MF can function as the etching stopper.

From the above fact, there are obtained such advantages that the height of the wire grid structure WG can be processed with precision, and a process margin can be also ensured. That is, the light absorbing layer ABL has an original function of absorbing the light as well as an additional function as the etching stopper. As described above, according to the second embodiment, the reflection polarization element with high precision can be manufactured.

In particular, in the second embodiment, since the light absorbing layer ABL can also function as the etching stopper, the height of the wire grid structure WG formed on the light absorbing layer ABL can be uniformed. That is, the wire grid structure WG can be formed by etching the metal film MF, but the etching rate of the metal film MF may be slightly varied depending on the area. In this case, in order to prevent etching remainder from occurring, etching needs to be conducted in a slightly overetching manner. Even in this case, the light absorbing layer ABL formed in the lower layer of the metal film MF functions as the etching stopper. As a result, even if overetching is conducted, the variation of the heights of the metal thin lines in each area can be suppressed, and the uniformity of the heights of the metal thin lines periodically arranged can be improved. Further, since the processing precision can be improved, according to the method for manufacturing the optical device in the second embodiment, there can be obtained such advantages that the effective height of the wire grid structure WG is easily set to correspond to λ/4 (λ is a wavelength), and the reflection polarization element with high performance can be manufactured.

### Modified Example

In the second embodiment, the light absorbing layer is disposed in the lower layer of the wire grid structure WG. Further, the surface roughness of the light absorbing layer may be roughened. That is, the technical concept of the second embodiment may be combined with the technical concept of the first embodiment. In this case, in the configuration of this modified example, the light absorbing layer ABL is disposed in the lower layer of the wire grid structure WG, and the surface roughness of the light absorbing layer ABL is made rougher than the surface roughness of the upper surface of the wire grid structure WG. In other words, in the configuration of this modified example, the light absorbing layer ABL is disposed in the lower layer of the wire grid structure WG, and the standard deviation corresponding to the surface roughness of the light absorbing layer ABL is made larger than the standard deviation corresponding to the surface roughness of the upper surface of the wire grid structure WG.

According to the modified example configured as described above, the effect of increasing the absorptivity of the TM polarized light can be obtained with an increase in the surface area of the light absorbing layer ABL caused by roughening the surface roughness of the light absorbing layer ABL, in addition to the effect (absorption effect) of reducing the reflectance of the TM polarized light caused by the provision of the light absorbing layer ABL. Further, the surface roughness of the light absorbing layer ABL is roughened with the results that the phase is disturbed, and the scattering (diffused reflection) of the TM polarized light is also liable to occur, thereby obtaining the effect of reducing the rate of the TM polarized light which is regularly reflected.

Therefore, according to this modified example, there can be obtained the synergistic effects of (1) the provision of the light absorbing layer ABL, (2) an increase in the surface area of the light absorbing layer ABL, and (3) an increase in the irregular refraction of the TM polarized light. With the synergistic effects, a large contrast can be obtained between the reflectance of the TE polarized light and the reflectance of the TM polarized light. As a result, according to the reflection polarization element of this modified example, there can be provided the reflection polarization element that is excellent in the tolerance to heat and light, and higher in the performance.

### Third Embodiment

In a third embodiment, a description will be given of an optical apparatus employing the reflection polarization element of the above first or second embodiment with reference to the drawings. In the third embodiment, a liquid crystal projector which is particularly one of image projection devices among a variety of optical apparatuses will be described as one example.

### <Configuration of Liquid Crystal Projector>

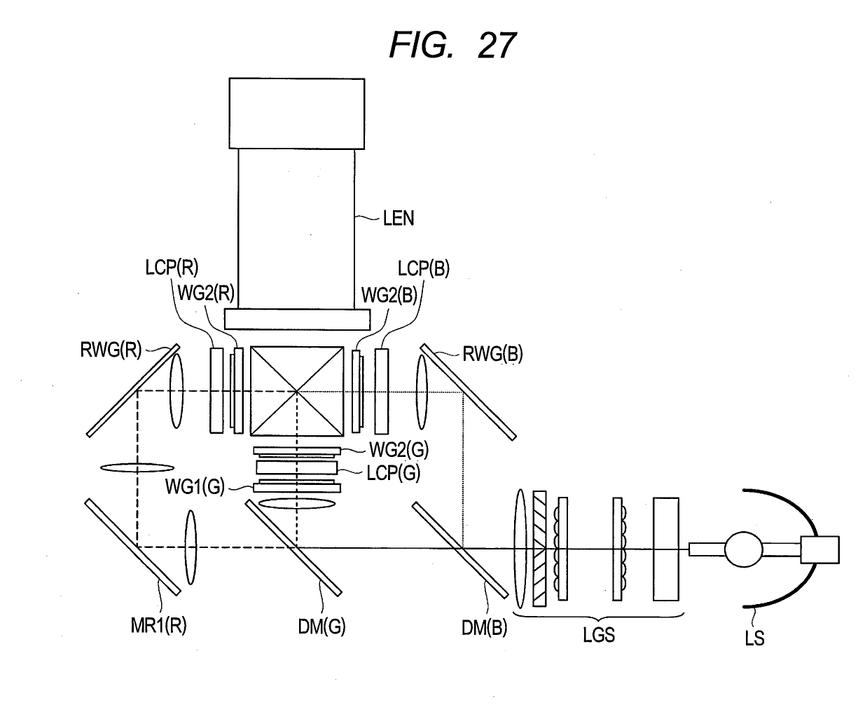

FIG. 27 is a schematic view illustrating an optical system of a liquid crystal projector according to a third embodiment. Referring to FIG. 27, the liquid crystal projector according to the third embodiment includes a light source LS, a waveguide optical system LGS, dichroic mirrors DM(B), DM(G), a reflective mirror MR1(R), reflection polarization elements RWG(B), RWG(R), liquid crystal panels LCP(B), LCP(G), LCP(R), transmission polarization elements WG1(G), WG2(G), WG2(B), WG2(R), and a projector lens LEN.

The light source LS is configured by a halogen lamp, and outputs a white light including a blue light, a green light, and a red light. The waveguide optical system is configured to uniform or collimate a light distribution output from the light source LS.

The dichroic mirror DM(B) is configured to reflect the light of the wavelength corresponding to the blue light, and transmit the other green light and red light. Likewise, the dichroic mirror DM(G) is configured to reflect the light of the wavelength corresponding to the green light, and transmit the other red light. Also, the reflective mirror MR1(R) is configured to reflect the red light.

The reflection polarization element RWG(B) is configured to receive the blue light, and selectively reflect a specific polarized light, and the reflection polarization element RWG(R) is configured to receive the red light and selectively reflect a specific polarized light. Specifically, the reflection polarization element RWG(B) and the reflection polarization element RWG(R) are the reflection polarization element described in the first embodiment and the second embodiment. For example, when the reflection polarization element corresponds to the first embodiment, as illustrated in FIG. 4, in the first surface and the second surface of the irregular configuration portion configuring the wire grid structure WG, the surface roughness of the first surface (surface SUR1) farther from the input side of the light (electromagnetic wave) is made rougher than the surface roughness of the second surface (surface SUR2) closer to the input side of the light (electromagnetic wave). On the other hand, when the reflection polarization element corresponds to the second embodiment, as illustrated in FIG. 23, the light absorbing layer ABL is disposed in the lower layer of the wire grid structure WG.

The liquid crystal panel LCP(B) is configured to receive the polarized light output from the reflection polarization element RWG(B) for blue, and conduct the intensity modulation of the polarized light according to image information. Likewise, the liquid crystal panel LCP(G) is configured to receive the polarized light output from the reflection polarization element RW1(G) for green, and conduct the intensity modulation of the polarized light according to image information. The liquid crystal panel LCP(R) is configured to receive the polarized light output from the reflection polarization element RWG(R) for red, and conduct the intensity modulation of the polarized light according to image information. Those liquid crystal panels LCP(B), LCP(G), and LCP(R) are electrically connected to a control circuit (not shown) that controls the liquid crystal panel, and a voltage to be applied to the liquid crystal panel is controlled on the basis of a control signal from the control circuit.

The transmission polarization elements WG1(G) and WG2(G) are transmission polarization elements for green, and configured to selectively transmit only a specific polarized light included in the green light. Likewise, the transmission polarization element WG2(B) is a transmission polarization element for blue, and configured to selectively transmit only a specific polarized light included in the blue light. The transmission polarization element WG2(R) is a transmission polarization element for red, and configured to selectively transmit only a specific polarized light included in the red light. The projector lens LEN is configured to project an image.

### <Operation of Liquid Crystal Projector>

The liquid crystal projector according to the third embodiment is configured as described above, and the operation of the liquid crystal projector will be described below. First, as illustrated in FIG. 27, the white light including the blue light, the green light, and the red light is output from the light source LS configured by a halogen lamp or the like. Then, the white light output from the light source LS is input to the waveguide optical system LGS to uniform or collimate the light distribution of the white light. Thereafter, the white light output from the waveguide optical system LGS is first input to the dichroic mirror DM(B). Only the blue light included in the white light is reflected by the dichroic mirror DM(B), and the green light and the red light are transmitted through the dichroic mirror DM(B).

The green light and the red light that have been transmitted through the dichroic mirror DM(B) are input to the dichroic mirror DM(G). Only the green light is reflected by the dichroic mirror DM(G), and the red light is transmitted through the dichroic mirror DM(G). In this way, the white light can be separated into the blue light, the green light, and the red light.

Subsequently, the separated blue light is input to the reflection polarization element RWG(B), and a specific polarized light included in the blue light is selectively reflected. Then, the selectively reflected polarized light is input to the liquid crystal panel LCP (B). In the liquid crystal panel LCP (B), the intensity modulation of the input polarized light is conducted on the basis of the control signal. Thereafter, the intensity modulated polarized light is output from the liquid crystal panel LCP(B), and input to the transmission polarization element WG2(B), and thereafter the polarized light is output from the transmission polarization element WG2(B).

Likewise, the separated green light is input to the reflection polarization element WG1(G), and a specific polarized light included in the green light is selectively reflected. Then, the selectively reflected polarized light is input to the liquid crystal panel LCP(G). In the liquid crystal panel LCP(G), the intensity modulation of the input polarized light is conducted on the basis of the control signal. Thereafter, the intensity modulated polarized light is output from the liquid crystal panel LCP(G), and input to the transmission polarization element WG2(G), and thereafter the polarized light is output from the transmission polarization element WG2(G).

Also, the separated red light is input to the reflection polarization element RWG(R), and a specific polarized light included in the red light is selectively reflected. Then, the selectively reflected polarized light is input to the liquid crystal panel LCP(R). In the liquid crystal panel LCP(R), the intensity modulation of the input polarized light is conducted on the basis of the control signal. Thereafter, the intensity modulated polarized light is output from the liquid crystal panel LCP(R), and input to the transmission polarization element WG2(R), and thereafter the polarized light is output from the transmission polarization element WG2(R).

Thereafter, the polarized light (blue) output from the transmission polarization element WG2(B), the polarized light (green) output from the transmission polarization element WG2(G), and the polarized light (red) output from the transmission polarization element WG2(R) are coupled together, and projected onto a screen (not shown) through the projector lens LEN. In this way, in the liquid crystal projector according to the third embodiment, the image can be projected.

### <Advantages of Liquid Crystal Projector According to the Third Embodiment>

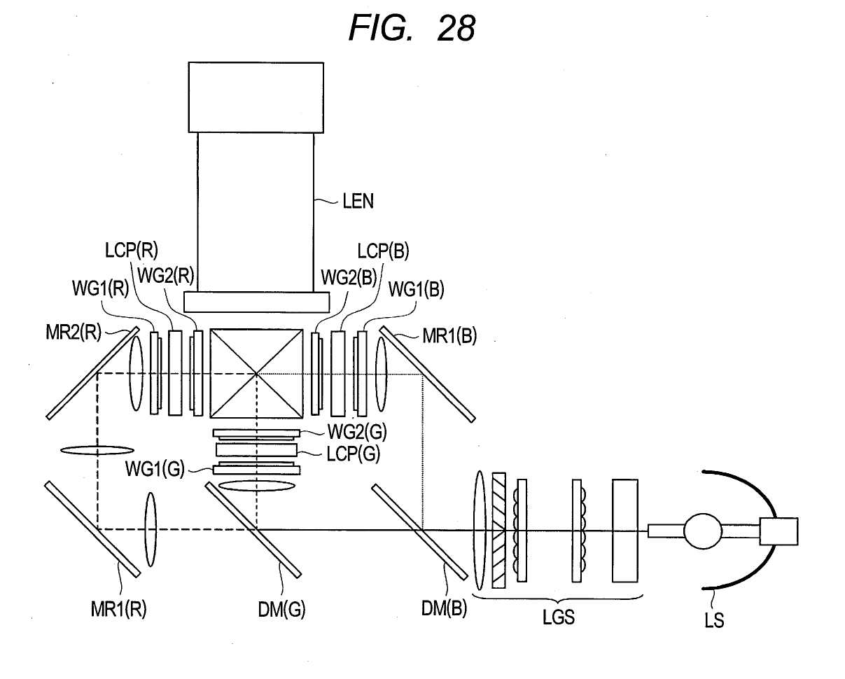

FIG. 28 is a schematic view illustrating an optical system of a liquid crystal projector in the related art. Differences between the liquid crystal projector in the related art illustrated in FIG. 28 and the liquid crystal projector in the third embodiment illustrated in FIG. 27 will be described. In the liquid crystal projector in the related art illustrated in FIG. 28, for example, the reflective mirror MR1(R) and the transmission polarization element WG1(B) are configured as different parts. Likewise, for example, the reflective mirror MR2(R) and the transmission polarization elements WG1(R) are configured as different parts.

On the contrary, in the liquid crystal projector according to the third embodiment illustrated in FIG. 27, for example, the combination of the reflective mirror MR1(R) and the transmission polarization element WG1(G) is replaced with the reflection polarization element RWG(B) having both functions of the reflective mirror and the polarization plate. Likewise, the combination of the reflective mirror MR2(R) and the transmission polarization element WG1(R) is replaced with the reflection polarization element RWG(B) having both functions of the reflective mirror and the polarization plate.

As a result, in the liquid crystal projector according to the third embodiment, the number of components can be reduced as compared with the liquid crystal projector in the related art. Therefore, according to the third embodiment, there can be obtained such advantages that the liquid crystal projector can be downsized, and the costs can be reduced.

### <Additional Statements>

The image projection device according to the third embodiment includes the following configurations.

### (Additional Statement 1)

An image projection device including (a) a light source, (b) a first polarization element that selectively reflects a specific polarized light from a light output from the light source, (c) a liquid crystal panel that receives the polarized light output from the first polarization element, and conducts intensity modulation of the polarized light according to image information, (d) a second polarization element that receives the polarized light output from the liquid crystal panel, and (e) a projector lens that receives the polarized light output from the second polarization element, and projects an image, in which the first polarization element has an irregular configuration portion with a cyclic structure that receives the light, and in a first surface and a second surface configuring the irregular configuration portion, the surface roughness of the first surface farther from the input side of the light is rougher than the surface roughness of the second surface closer to the input side of the light.

### (Additional Statement 2)

An image projection device including (a) a light source, (b) a first polarization element that selectively reflects a specific polarized light from a light output from the light source, (c) a liquid crystal panel that receives the polarized light output from the first polarization element, and conducts intensity modulation of the polarized light according to image information, (d) a second polarization element that receives the polarized light output from the liquid crystal panel, and (e) a projector lens that receives the polarized light output from the second polarization element, and projects an image, in which the first polarization element includes an irregular configuration portion with a cyclic structure that receives the light, and an absorption layer that absorbs the light which is disposed in a lower layer of the irregular configuration portion.

The invention made by the present inventors has been described specifically with reference to the embodiments. However, the present invention is not limited to the above embodiments, but can be variously modified without departing from the subject matter thereof.

For example, in the above embodiments, the optical device or the optical apparatus which deal with the visible light to the near-infrared light has been described. However, the present invention is not limited to this configuration, and the technical concept of the present invention can be likewise applied to the electromagnetic wave that conforms to the Maxwell equations. Specifically, in a wireless device of 77 GHz, a wavelength of the electromagnetic wave (light) is about 4 mm, and the reflection polarization element configured by pitches smaller than the wavelength can be applied to that electromagnetic wave as an optical component (polarization plate). In this case, the optical device can be prepared by using a press work or a grinding work.

<Comparison with the Related Art>

Finally, in order to clarify differences between the related art document (Japanese Unexamined Patent Application Publication No. 2011-81154) and the technical concepts of the present invention, a comparison therebetween is conducted.

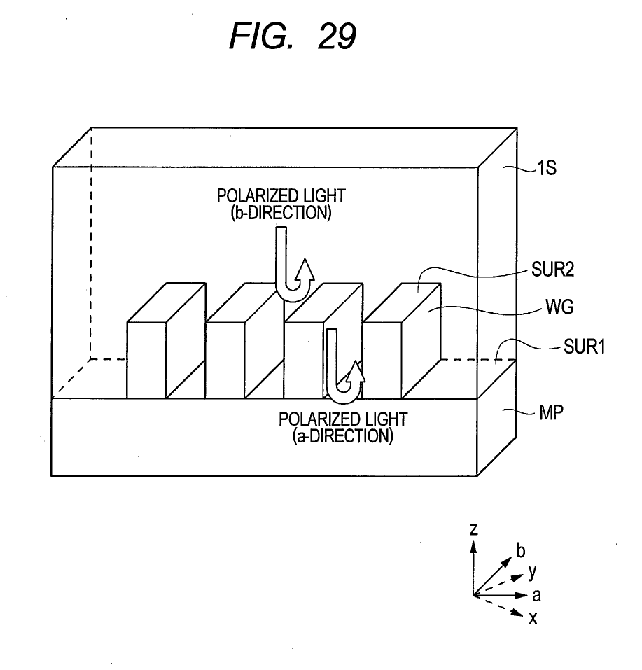

FIG. 29 is a schematic view illustrating a configuration of an optical device (half-wavelength plate) disclosed in the related art document. Referring to FIG. 29, in the optical device in the related art, the wire grid structure WG is formed on the reflective mirror portion MP. In this example, an orientation of the wire grid structure WG is arranged with rotation of 40 degrees on an x-y plane, a direction resulting from rotating the x-direction by 45 degrees is defined as an a-direction, and a direction resulting from rotating the y-direction by 45 degrees is defined as a b-direction. In this case, when the polarized light (b-direction) whose oscillating direction of the electric field is the b-direction is first input to the optical device, the polarized light (b-direction) is reflected on the upper surface (surface SUR2) of the wire grid structure WG with the same mechanism as the mechanism described in FIG. 3.

On the other hand, when the polarized light (a-direction) whose oscillating direction of the electric field is the a-direction is first input to the optical device, the polarized light passes through the wire grid structure WG, and reaches the bottom surface (surface SUR1) of the wire grid structure WG with the same mechanism as the mechanism described in FIG. 2. The polarized light (a-direction) that has reached the bottom surface (surface SUR1) of the wire grid structure WG is reflected by the surface SUR1.

In the technique disclosed in the above-mentioned related art document, the polarized light (b-direction) reflected by the surface SUR2, and the polarized light (a-direction) reflected by the surface SUR1 are again superimposed on each other, and reflected from the optical device. In this situation, the polarized light (a-direction) reflected by the surface SUR1 becomes longer in optical length than the polarized light reflected by the surface SUR2 by a distance reciprocating a height of the wire grid structure WG. Then, the optical device is designed so that the optical path length becomes a half wavelength. As a result, when the polarized light (b-direction) and the polarized light (a-direction) are again superimposed on each other, a phase of the polarized light (a-direction) is shifted by 180 degrees. That is, the phase of the polarized light (a-direction) included in the incident light and the phase of the polarized light (a-direction) included in the reflected light are shifted from each other by 180 degrees. As a result, the polarization direction of the incident light and the polarization direction of the reflected light are different from each other by 90 degrees. In this way, the optical device disclosed in the related art document functions as the half-wavelength plate.

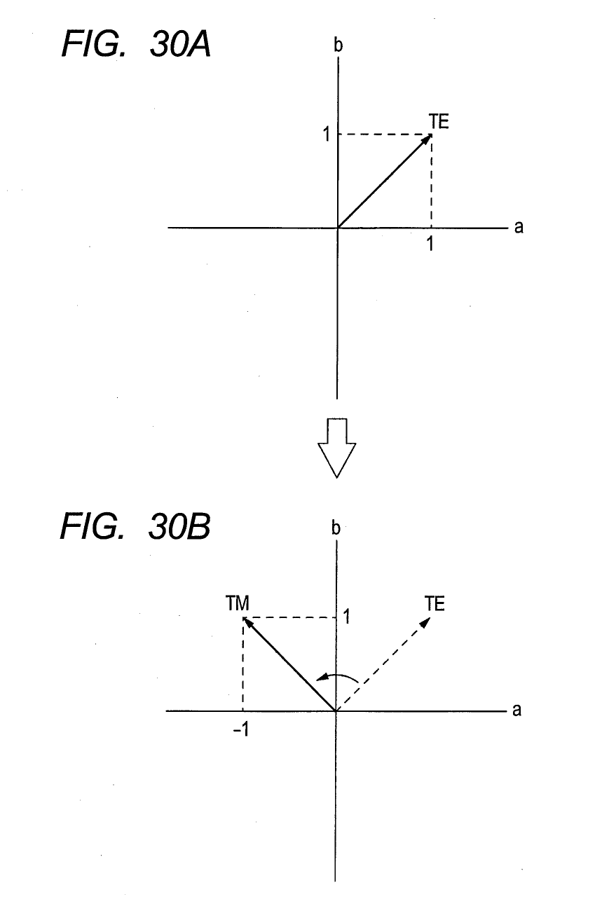

Specifically, FIGS. 30A and 30B are diagrams illustrating the function of the half-wavelength plate. FIG. 30A illustrates a case in which the TE polarized light is input to the optical device in the related art document. Since the optical device in the related art document rotates by 45 degrees on the x-y plane, both of a vector component in the a-direction and a vector component in the b-direction in the TE polarized light are “1”, for example, as illustrated in FIG. 30A. FIG. 30B illustrates the reflected light from the optical device disclosed in the related art document. As described above, in the reflected light reflected from the optical device in the prior art document, the optical path length of the polarized light in the a-direction is longer than the optical path length of the polarized light in the b-direction by the half wavelength. As a result, the phase of the polarized light in the a-direction is shifted by 180 degrees. This represents that the vector component in the a-direction is changed from “1” to “−1” as illustrated in FIG. 30B.

As a result, it is found that the reflected light becomes the TM polarized light whose polarization direction is different from that of the TE polarized light which is the incident light by 90 degrees. That is, it is found that the optical device in the related art document functions as the half-wavelength plate. In this example, an important point is that in order to allow the optical device of the related art document to excellently function as the half-wavelength plate, the reflectance of the polarized light (b-direction) reflected by the upper surface (surface SUR2) of the wire grid structure WG needs to be equal to the reflectance of the polarized light (a-direction) reflected by the bottom surface after having been transmitted through the wire grid structure WG.

On the contrary, the optical device according to the present invention functions as not the half wavelength plate, but the polarization element, which is largely different from the optical device in the related art document. In order to function as the polarization element, the optical device according to the present invention needs to function to reflect the TE polarized light, and absorb the TM polarized light, for example, as illustrated in FIG. 6. That is, an important point of the present invention resides in that the TE polarized light is reflected by the upper surface (surface SUR2) of the wire grid structure WG while the reflectance of the TM polarized light reflected by the bottom surface after having been transmitted through the wire grid structure WG needs to be substantially zero. With this configuration, the optical device according to the present invention can function as the polarization element.

Accordingly, it is found that the present invention is large different from the related art document in that the optical device according to the present invention needs to function as the polarization element whereas the optical device in the related art document needs to function as the half-wavelength plate. Because of this difference in the function, in the related art document, the reflectance of the polarized light (b-direction) reflected by the upper surface (surface SUR2) of the wire grid structure WG needs to be equal to the reflectance of the polarized light (a-direction) reflected by the bottom surface after having been transmitted through the wire grid structure WG. On the contrary, in the present invention, the TE polarized light is reflected on the upper surface (surface SUR2) of the wire grid structure WG while the reflectance of the TM polarized light reflected by the bottom surface after having been transmitted through the wire grid structure WG is substantially zero. From this viewpoint, it is found that the basic concept of the present invention is entirely different from the basic concept of the related art document.

From the above viewpoint, it is found that the basic concept of the present invention is entirely different from the basic concept of the related art document. Accordingly, it would be difficult to conceive the present invention from the related art document even by an ordinary skilled person.

The present invention can be widely used in the manufacturing industry for manufacturing the optical device.

What is claimed is:

1. A optical device, comprising:
an irregular configuration portion with a periodic structure to which an electromagnetic wave is input,
wherein in first and second faces configuring surfaces of the irregular configuration portion,
a surface roughness of the first face farther from an input side of the electromagnetic wave is rougher than the surface roughness of the second face closer to the input side of the electromagnetic wave.

2. The optical device according to claim 1,
wherein when the surface roughness is expressed by a standard deviation in a normal distribution,
a first standard deviation corresponding to the surface roughness of the first face is larger than a second standard deviation corresponding to the surface roughness of the second face.

3. The optical device according to claim 2,
wherein the first standard deviation ranges from 22 nm to 44 nm.

4. The optical device according to claim 1,
wherein the electromagnetic wave includes a first polarized light, and a second polarized light having a polarization direction orthogonal to that of the first polarized light,
wherein the first face absorbs the first polarized light, and
wherein the second face reflects the second polarized light.

5. The optical device according to claim 1,
wherein the electromagnetic wave includes a first polarized light, and a second polarized light having a polarization direction orthogonal to that of the first polarized light, and
wherein a reflectance of the first polarized light on the first face is smaller than the reflectance of the second polarized light on the second face.

6. The optical device according to claim 5,
wherein the reflectance of the first polarized light on the first face is 1% or smaller, and
wherein the reflectance of the second polarized light on the second face is 85% or larger.

7. The optical device according to claim 1,
wherein a period of the irregular configuration portion is smaller than a wavelength of the electromagnetic wave.

8. The optical device according to claim 1,
wherein the optical device is a reflective polarization plate.

9. An optical device, comprising:
an irregular configuration portion having a periodic structure to which an electromagnetic wave is input; and
an absorption layer that is disposed in a lower layer of the irregular configuration portion, and absorbs the electromagnetic wave.

10. The optical device according to claim 9,
wherein the electromagnetic wave includes a first polarized light, and a second polarized light having a polarization direction orthogonal to that of the first polarized light, and
wherein the first polarized light is absorbed by the absorption layer, and
wherein the second polarized light is reflected on an upper surface configuring the irregular configuration portion.

11. The optical device according to claim 9,
wherein the electromagnetic wave includes a first polarized light, and a second polarized light having a polarization direction orthogonal to that of the first polarized light, and
wherein a reflectance of the first polarized light on the absorption layer is smaller than the reflectance of the second polarized light on the upper surface configuring the irregular configuration portion.

12. The optical device according to claim 9,
wherein the absorption layer is formed of one of a metal oxide film and a metal nitride film.

13. A method for manufacturing an optical device, comprising the steps of:
(a) preparing a substrate;
(b) forming an irregular configuration portion with a periodic structure on a surface of the substrate; and
(c) forming a metal film reflecting a shape of the irregular configuration portion, on the substrate on which the irregular configuration portion is formed, through a film forming technique having a directivity.

14. The method for manufacturing an optical device according to claim 13,
wherein the step (c) includes a film forming step using a particle beam in which a motion energy of metal particles is located in a thickness direction of the substrate.

15. The method for manufacturing an optical device according to claim 13,
wherein the step (c) includes a step of making the surface roughness of a bottom surface of a concave of the metal film rougher than the surface roughness of an upper surface of a convex of the metal film.
